(19) United States
(12) Patent Application Publication
(10) Pub. No.: US 2026/0064423 A1
(43) Pub. Date: Mar. 5, 2026

(54) INSTRUCTION EXECUTION METHOD, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Shufan DENG, Shenzhen (CN); Zhiqiang DONG, Shenzhen (CN); Bin LI, Shenzhen (CN)

(21) Appl. No.: 19/315,815

(22) Filed: Sep. 1, 2025

Related U.S. Application Data
(63) Continuation of application No. PCT/CN2023/132781, filed on Nov. 21, 2023.

(30) Foreign Application Priority Data
Jun. 30, 2023 (CN) 202310801069.3

(51) Int. Cl. G06F 9/38; G06F 9/455

(52) U.S. Cl. CPC G06F 9/3836; G06F 9/455

(57) ABSTRACT

An instruction execution method includes: receiving demand information of a target object; executing at least one round of target operation until a candidate execution instruction passing executability verification is obtained; in a first round of target operation, invoking the language model to perform instruction recognition on the demand information, and performing executability verification to determine whether the candidate execution instruction of the first round passes executability verification; in an i^{th} round of target operation, invoking the language model to perform the instruction recognition according to a candidate execution instruction of an (i−1)^{th} round of target operation and a guidance prompt information, followed by executability verification on the candidate execution instruction of the i^{th} round of target operation; and using the candidate execution instruction passing executability verification as a target execution instruction, and controlling a terminal to execute an operation task corresponding to the demand information.

### CROSS-REFERENCES TO RELATED APPLICATIONS

This application is a continuation application of PCT Patent Application No. PCT/CN2023/132781, filed on Nov. 21, 2023, which claims priority to Chinese Patent Application No. 2023108010693, filed on Jun. 30, 2023, all of which is incorporated herein by reference in their entirety.

### FIELD OF THE TECHNOLOGY

The present disclosure relates to the field of artificial intelligence technologies, and in particular, to natural language processing technologies.

### BACKGROUND OF THE DISCLOSURE

With the development of artificial intelligence technologies, many terminal devices can support interaction with a user. For example, the user may interact with the terminal device through voice or text. When a terminal device recognizes user's commends, the terminal device may perform various operations, such as starting an application, checking the weather, or playing music, according to the recognized commends.

The terminal device generally recognizes the user's commends based on a neural network model. However, the neural network model cannot always accurately recognize the user's commends. When the neural network model cannot accurately recognize the user's commends, the user must rephrase the command and interact with the terminal device again until the neural network model can accurately recognize the rephrase the command. This process requires multiple rounds of interactions between the user and the terminal device to allow the terminal device to correctly execute an operation desired by the user, which causes problems such as low interaction efficiency and poor user experience.

### SUMMARY

One embodiment of the present disclosure provides an instruction execution method based on a language model, which is performed by a computer device. The method includes: receiving demand information of a target object; executing at least one round of target operation until a candidate execution instruction passing executability verification is obtained; in a first round of target operation, invoking the language model to perform instruction recognition on the demand information according to preset guidance prompt information, to obtain a candidate execution instruction of the first round of target operation, and performing the executability verification on the candidate execution instruction of the first round of target operation to determine whether the candidate execution instruction of the first round of target operation passes the executability verification; in an i^{th} round of target operation, invoking the language model to perform the instruction recognition on the demand information according to a candidate execution instruction of an (i−1)^{th} round of target operation and the guidance prompt information, to obtain a candidate execution instruction of the i^{th} round of target operation, and performing the executability verification on the candidate execution instruction of the i^{th} round of target operation to determine whether the candidate execution instruction of the i^{th} round of target operation passes the executability verification, i being an integer greater than 1; and using the candidate execution instruction passing the executability verification as a target execution instruction, and controlling, according to the target execution instruction, a terminal to execute an operation task corresponding to the demand information.

Another embodiment of the present disclosure provides a computer device. The computer device includes one or more processors; and at least one memory, configured to store at least one program that, when being executed causes the one or more processors to perform: receiving demand information of a target object; executing at least one round of target operation until a candidate execution instruction passing executability verification is obtained; in a first round of target operation, invoking the language model to perform instruction recognition on the demand information according to preset guidance prompt information, to obtain a candidate execution instruction of the first round of target operation, and performing the executability verification on the candidate execution instruction of the first round of target operation to determine whether the candidate execution instruction of the first round of target operation passes the executability verification; in an i^{th} round of target operation, invoking the language model to perform the instruction recognition on the demand information according to a candidate execution instruction of an (i−1)^{th} round of target operation and the guidance prompt information, to obtain a candidate execution instruction of the i^{th} round of target operation, and performing the executability verification on the candidate execution instruction of the i^{th} round of target operation to determine whether the candidate execution instruction of the i^{th} round of target operation passes the executability verification, i being an integer greater than 1; and using the candidate execution instruction passing the executability verification as a target execution instruction, and controlling, according to the target execution instruction, a terminal to execute an operation task corresponding to the demand information.

Another embodiment of the present disclosure provides a non-transitory computer-readable storage medium containing a computer program that, when being executed causes at least one processor to perform: receiving demand information of a target object; executing at least one round of target operation until a candidate execution instruction passing executability verification is obtained; in a first round of target operation, invoking the language model to perform instruction recognition on the demand information according to preset guidance prompt information, to obtain a candidate execution instruction of the first round of target operation, and performing the executability verification on the candidate execution instruction of the first round of target operation to determine whether the candidate execution instruction of the first round of target operation passes the executability verification; in an i^{th} round of target operation, invoking the language model to perform the instruction recognition on the demand information according to a candidate execution instruction of an (i−1)^{th} round of target operation and the guidance prompt information, to obtain a candidate execution instruction of the i^{th} round of target operation, and performing the executability verification on the candidate execution instruction of the i^{th} round of target operation to determine whether the candidate execution instruction of the i^{th} round of target operation passes the executability verification, i being an integer greater than 1; and using the candidate execution instruction passing the executability verification as a target execution instruction, and controlling, according to the target execution instruction, a terminal to execute an operation task corresponding to the demand information.

### BRIEF DESCRIPTION OF THE DRAWINGS

FIG. 1 is a schematic diagram of an implementation environment according to an embodiment of the present disclosure.

FIG. 2 is a schematic diagram of another implementation environment according to an embodiment of the present disclosure.

FIG. 3 is a flowchart of an instruction execution method based on a language model according to an embodiment of the present disclosure.

FIG. 4 is a schematic diagram of structural content of guidance prompt information according to an embodiment of the present disclosure.

FIG. 5 is a schematic diagram of a process of replacing an instruction functional function with an empty function according to an embodiment of the present disclosure.

FIG. 6 is a schematic diagram of an interface interacting with a terminal through an artificial intelligence interaction module according to an embodiment of the present disclosure.

FIG. 7 is a schematic diagram of content of guidance prompt information according to an embodiment of the present disclosure.

FIG. 8 is a schematic diagram of an interface interacting with a terminal through an artificial intelligence interaction module according to another embodiment of the present disclosure.

FIG. 9 is an overall flowchart of an instruction execution method based on a language model according to an example of the present disclosure.

FIG. 10 is a flowchart of operations of an instruction execution method based on a language model according to a specific example of the present disclosure.

FIG. 11 is a schematic diagram of an instruction execution apparatus based on a language model according to an embodiment of the present disclosure.

FIG. 12 is a schematic diagram of another instruction execution apparatus based on a language model according to an embodiment of the present disclosure.

### DESCRIPTION OF EMBODIMENTS

The present disclosure is further described below with reference to accompanying drawings of the specification and specific embodiments. The embodiments described are not construed as limitations on the present disclosure. All other embodiments obtained by a person of ordinary skill in the art without creative efforts fall within the protection scope of the present disclosure.

When a user performs an operation task by using a terminal device, generally, the user needs to manually operate the terminal device to complete the operation task, for example, manually dragging a window, manually starting an application, or manually entering a query requirement in a browser to obtain desired search content. Since these operations need to be manually performed by the user, there are problems of low interaction intelligence and low interaction efficiency. In addition, when the operation path of the operation task is relatively long, the user needs to perform relatively complex operation steps to complete the operation task. Consequently, there is a problem of poor user experience.

To resolve these problems, in related technologies, interaction between a user and a terminal device is achieved through voice or text, so that the terminal device recognizes a requirement instruction sent by the user in an interaction process, and executes different operation tasks such as starting an application, checking weather, or playing music according to the recognized requirement instruction. In related technologies, a requirement instruction of a user is usually recognized by using a neural network model. However, an output result of the neural network model is probabilistic, and the neural network model cannot always accurately recognize a requirement instruction of a user. When the neural network model cannot accurately recognize the requirement instruction of the user, the user needs to interact with the terminal device again in another way of describing the requirement instruction. For example, assuming that the neural network model cannot accurately recognize a voice instruction “give me music” of the user, the user needs to change the voice instruction into “play music” to interact with the terminal device again until the neural network model can accurately recognize the requirement instruction of the user. It can be seen that in the foregoing process, the user needs to interact with the terminal device repeatedly to enable the terminal device to correctly execute the operation task desired by the user, causing problems such as low interaction efficiency and poor user experience.

To improve the efficiency of interaction between a user and a terminal device and improve the use experience of the user, an embodiment of the present disclosure provides an instruction execution method based on a language model. In the method, when demand information (or request information) of a target object is received, at least one round of the target operation is executed until a candidate execution instruction passing executability verification (or executability check) is obtained. In the first round of target operation, the language model is first invoked to perform instruction recognition on the demand information according to the preset guidance prompt information, to obtain the candidate execution instruction of the first round of target operation. The candidate execution instruction is obtained by performing, by the language model, the instruction recognition on the demand information according to the guidance prompt information. Therefore, the confidence level of the candidate execution instruction can be increased, thereby helping to obtain a candidate execution instruction having a higher matching degree with the demand information. Then, the executability verification is performed on the candidate execution instruction of the first round of target operation to determine whether the candidate execution instruction passes the executability verification; and if the candidate execution instruction fails to pass the executability verification, it indicates that the candidate execution instruction obtained by the current language model through recognition is inaccurate. In this case, a next round of target operation is performed. In the next round of target operation, the language model is invoked to re-perform the instruction recognition on the demand information according to the candidate execution instruction in the previous target operation and the guidance prompt information, to obtain a candidate execution instruction of this round of target operation, and then the executability verification is re-performed on this candidate execution instruction to determine whether this candidate execution instruction passes the executability verification. Several rounds of target operations are repeatedly performed in this way until a candidate execution instruction passing the executability verification is obtained. In addition, after the candidate execution instruction passing the executability verification is obtained, the candidate execution instruction is used as a target execution instruction, and a terminal is controlled, according to the target execution instruction, to execute an operation task corresponding to the demand information. The candidate execution instruction passing the executability verification is obtained by invoking the language model to perform the instruction recognition on the demand information according to the guidance prompt information and the previous candidate execution instruction for many times. Therefore, the confidence level of the candidate execution instruction can be ensured. Moreover, this process is automatically completed, a target object does not need any additional operation, and the target object does not need repeated interaction. Therefore, the efficiency of interaction between the target object and the terminal can be improved, simplifying the use of the target object, thereby improving the use experience of the target object.

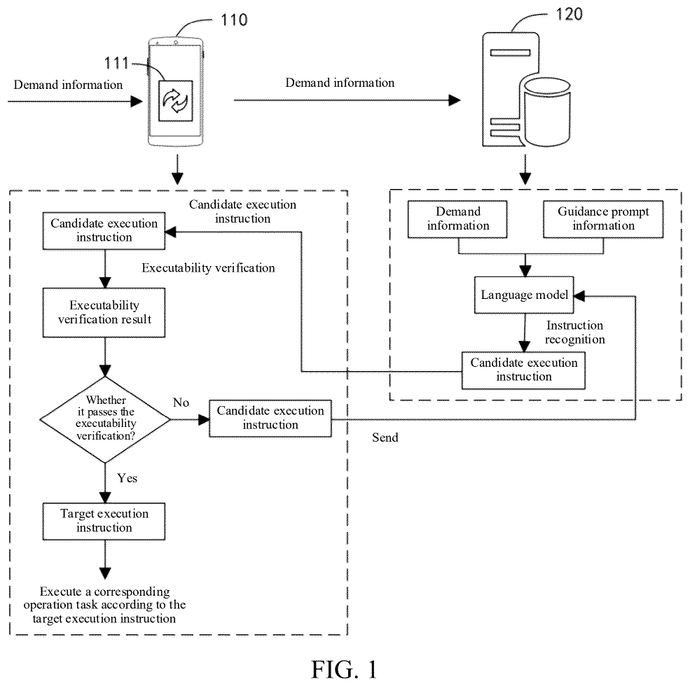

Referring to FIG. 1, FIG. 1 is a schematic diagram of an implementation environment according to an embodiment of the present disclosure. The implementation environment may include a first user terminal 110 and a first server 120. The first user terminal 110 and the first server 120 may be directly or indirectly connected in a wired or wireless communication mode. The first user terminal 110 and the first server 120 may be nodes in a block chain. This is not specifically limited in this embodiment.

The first server 120 may be a stand-alone physical server, may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. A trained language model may be deployed in the first server 120. The language model may be a large language model (LLM) that can perform interaction by learning and understanding human languages, a natural language understanding (NLU) model that can perform semantic recognition on voice information or text information entered by a user, or the like.

The first user terminal 110 includes but is not limited to a smartphone, a tablet, a computer, an intelligent voice interaction device, a smart home appliance, an on-board terminal, an aerial vehicle, and the like. In some embodiments, an artificial intelligence interaction module 111 may be provided in the first user terminal 110. By using the artificial intelligence interaction module 111, interaction between the user and the first user terminal 110 can be implemented, so that the first user terminal 110 automatically executes an operation task expected by the user according to demand information entered by the user. For example, the artificial intelligence interaction module 111 may be used to invoke a language model in the first server 120 to recognize the demand information entered by the user, so as to obtain an execution instruction corresponding to the demand information. Thus, the first user terminal 110 executes, according to the execution instruction, the operation task corresponding to the demand information.

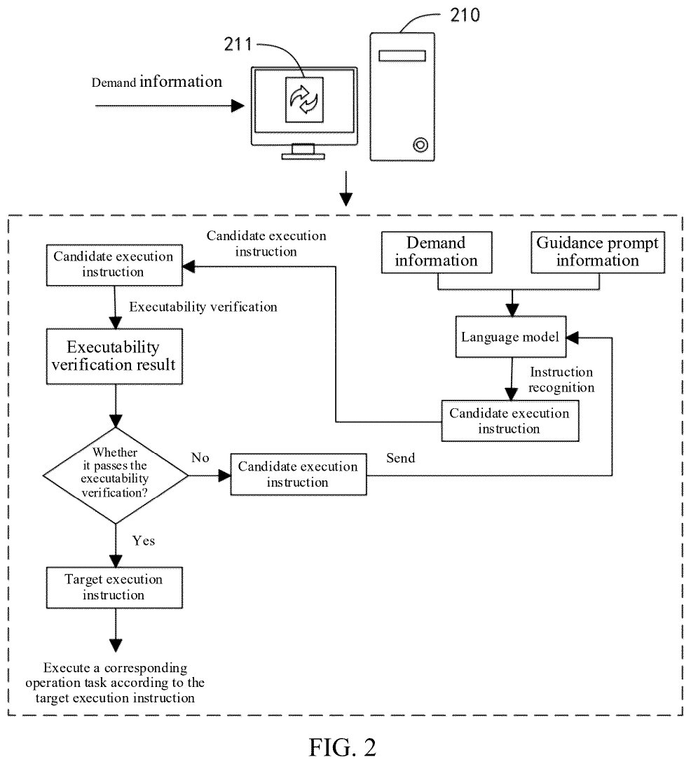

Referring to FIG. 2, FIG. 2 is a schematic diagram of another implementation environment according to an embodiment of the present disclosure. The implementation environment may include a second user terminal 210. The second user terminal 210 may be a node in a block chain. This is not specifically limited in this embodiment.

The second user terminal 210 may include but is not limited to a smartphone, a tablet, a computer, an intelligent voice interaction device, a smart home appliance, an on-board terminal, an aerial vehicle, and the like. In some embodiments, an artificial intelligence interaction module 211 may be provided in the second user terminal 210, and a trained language model may be deployed in the second user terminal 210. The language model may be an LLM model that can perform interaction by learning and understanding human languages, an NLU model that can perform semantic recognition on voice information or text information entered by a user, or the like. By using the artificial intelligence interaction module 211, interaction between the user and the second user terminal 210 can be implemented, so that the second user terminal 210 can automatically execute, according to the demand information entered by the user, an operation task expected by the user. For example, the artificial intelligence interaction module 211 may be used to invoke a language model in the second user terminal 210 to recognize the demand information entered by the user, so as to obtain an execution instruction corresponding to the demand information. Thus, the second user terminal 210 executes, according to the execution instruction, the operation task corresponding to the demand information.

As shown in FIG. 1 or FIG. 2, in an application scenario, after the first user terminal 110 or the second user terminal 210 receives the demand information entered by the user, the first user terminal 110 may invoke the language model in the first server 120 through an artificial intelligence interaction module 111 to perform instruction recognition on the demand information according to preset guidance prompt information, to obtain a candidate execution instruction. The second user terminal 210 may invoke the language model in the second user terminal 210 through the artificial intelligence interaction module 211 to perform instruction recognition on the demand information according to preset guidance prompt information, to obtain a candidate execution instruction.

When the user enters voice information, the first user terminal 110 or the second user terminal 210 first invokes a pre-trained voice recognition model to perform voice recognition on the voice information to obtain text information, and performs at least one processing of adding punctuations, correcting spelling errors, or correcting word order errors for the text information, to obtain the demand information. In addition, when invoking the pre-trained voice recognition model to perform the voice recognition on the voice information, the first user terminal 110 or the second user terminal 210 first performs at least one processing of noise removal and voice segmentation on the voice information to obtain preprocessed voice information, then invokes a pre-trained voice feature extraction model to perform voice feature extraction on the preprocessed voice information to obtain voice feature information, and subsequently invokes the pre-trained voice recognition model to perform the voice recognition on the voice feature information to obtain text information.

When invoking the language model to perform the instruction recognition on the demand information according to preset guidance prompt information to obtain a candidate execution instruction, the first user terminal 110 or the second user terminal 210 may first generate model-invoking request information according to the demand information and the preset guidance prompt information, and then send the model-invoking request information to an invoking interface of the language model in a first artificial intelligence generated content server 120 or an invoking interface of the language model in the second user terminal 210, so as to invoke, according to the model-invoking request information, the language model to perform the instruction recognition on the demand information according to the guidance prompt information, to obtain the candidate execution instruction.

After the first user terminal 110 or the second user terminal 210 obtains the candidate execution instruction recognized by the language model, the first user terminal 110 or the second user terminal 210 first performs executability verification on the candidate execution instruction, to obtain an executability verification result. When performing the executability verification on the candidate execution instruction, the first user terminal 110 or the second user terminal 210 first replaces an instruction functional function in the candidate execution instruction with an empty function whose function result is always true, to obtain a to-be-verified execution instruction, and then invokes an instruction execution engine to perform simulative execution on the to-be-verified execution instruction, to obtain a simulative execution result. If the simulative execution result indicates successful execution of the to-be-verified execution instruction, an executability verification result indicating that the candidate execution instruction passes the executability verification successfully may be obtained. If the simulative execution result indicates unsuccessful execution of the to-be-verified execution instruction, an executability verification result indicating that the candidate execution instruction fails to pass the executability verification may be obtained.

After the first user terminal 110 or the second user terminal 210 performs the executability verification on the candidate execution instruction to obtain the executability verification result, if the executability verification result is that the candidate execution instruction fails to pass the executability verification, the language model in the first server 120 or the second user terminal 210 is invoked to re-perform the instruction recognition on the demand information according to the candidate execution instruction and the guidance prompt information, to obtain a new candidate execution instruction, and re-perform the executability verification on the new candidate execution instruction. The foregoing process is repeated in this way until a candidate execution instruction passing the executability verification is obtained.

Subsequently, the first user terminal 110 or the second user terminal 210 uses the candidate execution instruction passing the executability verification as a target execution instruction, and an artificial intelligence interaction module 111 in the first user terminal 110 or an artificial intelligence interaction module 211 in the second user terminal 210 controls, according to the target execution instruction, the first user terminal 110 or the second user terminal 210 to execute the operation task corresponding to the demand information. When executing the operation task corresponding to the demand information according to the target execution instruction, the first user terminal 110 or the second user terminal 210 may first obtain a corresponding instruction execution code according to the target execution instruction, and then run the instruction execution code in a virtual environment, to simulate the user controlling the user terminal to execute the operation task corresponding to the demand information. In the process in which the first user terminal 110 or the second user terminal 210 runs the instruction execution code in the virtual environment to simulate the user controlling the user terminal to execute the operation task corresponding to the demand information, the first user terminal 110 or the second user terminal 210 first runs an instruction execution process in the virtual environment, and then invokes the instruction execution process to run the instruction execution code, to simulate the user controlling the user terminal to execute the operation task corresponding to the demand information.

When the first user terminal 110 or the second user terminal 210 includes a display module configured to display an operation cursor, when simulating the user controlling the user terminal to execute the operation task corresponding to the demand information, the first user terminal 110 or the second user terminal 210 may first invoke an application programming interface to obtain screen resolution of the display module, obtain initial coordinates of the operation cursor according to the screen resolution, then determine target coordinates for executing the operation task corresponding to the demand information, then simulate the user controlling the operation cursor to move from the initial coordinates to the target coordinates, and simulate the user controlling the user terminal to execute the operation task corresponding to the demand information at the target coordinates.

In addition, in the process in which the artificial intelligence interaction module 111 or the artificial intelligence interaction module 211 controls, according to the target execution instruction, the user terminal to execute the operation task corresponding to the demand information, an execution record table including the target execution instruction and the instruction execution code may further be created. The execution record table further includes an execution status entry and an execution result entry. When the first user terminal 110 or the second user terminal 210 executes and completes the operation task corresponding to the demand information, the first user terminal 110 or the second user terminal 210 updates content of the execution status entry in the execution record table as “Completed”, and writes the execution result into the execution result entry.

In each specific implementation of the present disclosure, when related processing needs to be performed according to data related to a characteristic of a target object, such as attribute information or an attribute information set of the target object (for example, a user), permission or consent of the target object is first obtained, and collection, use, processing, and the like of the data comply with related laws, regulations and standards. In addition, when attribute information of a target object needs to be obtained in the embodiments of the present disclosure, individual permission or individual consent of the target object is obtained through a pop-up window or jumping to a confirmation page. After the individual permission or the individual consent of the target object is explicitly obtained, target object-related data for enabling the embodiments of the present disclosure to operate normally is obtained.

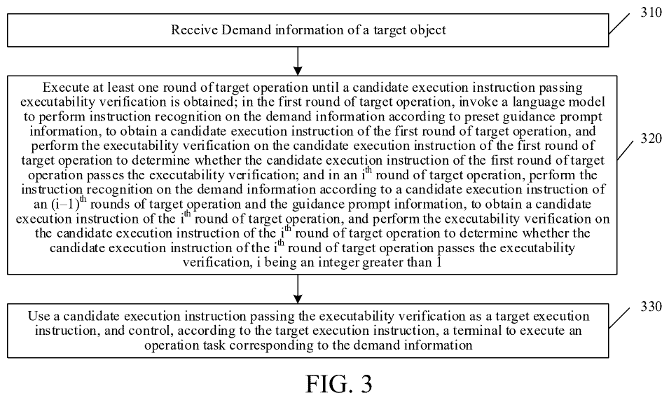

FIG. 3 is a flowchart of an instruction execution method based on a language model according to an embodiment of the present disclosure. The instruction execution method based on a language model may be executed by a computer device, for example, may be executed by a terminal or be jointly executed by a server and a terminal. In this embodiment of the present disclosure, an example in which the method is executed by a terminal is used for description. Referring to FIG. 3, the instruction execution method based on a language model may include, but is not limited to, operation 310 to operation 330.

Operation 310: Receive demand information of a target object.

In an embodiment, the demand information of the target object may be a direct control instruction of the target object for the terminal, or may be question content submitted by the target object to the terminal in hopes of receiving a corresponding answer from the terminal. This is not specifically limited herein. For example, when the demand information is a direct control instruction of the target object for the terminal, the demand information may be instruction content for directly controlling the terminal, such as “Play music”, “Open a browser”, and “Set an alarm at 10 in the morning”. For another example, when the demand information is question content submitted by the target object to the terminal in hopes of receiving a corresponding answer, the demand information may be question content such as “What is the weather like tomorrow”, “How to get to location A”, and “Which buses are going to city B”. The demand information “What is the weather like tomorrow” means the target object hopes the terminal to query a weather condition tomorrow on a weather forecast website, the demand information “How to get to location A” means the target object hopes the terminal to start a map application program to query a navigation route from a current location to location A, and the demand information “Which buses are going to city B” means the target object hopes the terminal to query a passenger transportation shift from a current city to city B on a passenger transportation website.

In an embodiment, the target object may be a user, or may be an external terminal in communication connection with a terminal that executes the instruction execution method. This is not specifically limited herein. When the target object is a user, the demand information of the target object may be text information directly entered by the user, or may be text information recognized from voice information entered by the user. This is not specifically limited herein. When the target object is an external terminal in communication connection with a terminal that executes the instruction execution method, the demand information of the target object may be text information sent by the external terminal, or may be text information recognized from voice information sent by the external terminal. This is not specifically limited herein.

In an embodiment, when the demand information is text information recognized from voice information of the target object (for example, voice information entered by a user or an external terminal), the terminal may first receive the voice information inputted by the target object, then invoke a pre-trained voice recognition model to perform voice recognition on the voice information to obtain the text information, and then perform at least one processing of adding punctuations, correcting spelling errors, or correcting word order errors for the text information, to obtain the demand information.

The pre-trained voice recognition model is configured to convert an audio feature vector of the voice information into text information. The voice recognition model may include a model commonly used in the art, such as a hidden Markov model (HMM), a Gaussian mixture model, a deep neural network model, an n-gram language model, or another statistical model. This is not specifically limited herein.

In an embodiment, the voice recognition model may further be obtained by combining and connecting an acoustic model and a language model in series. The acoustic model is configured to classify (decode) acoustic features into corresponding phonemes or words. The language model is configured to decode phonemes or words into a complete text. For example, the audio feature vector of the voice information may be first converted into an intermediate recognition result (for example, a phoneme, a phoneme string, or a sub-word) by using the acoustic model, then the intermediate recognition result is converted into a text recognition result (for example, a word, a word string, or a symbol sequence) by using the language model, and then the text information corresponding to the voice information of the target object is outputted.

In an embodiment, since the text information outputted by the voice recognition model is content such as a word, a word string, or a symbol sequence, there may be a problem that the demand information of the target object cannot be accurately expressed, thereby easily affecting the accuracy of instruction recognition subsequently performed on the demand information. To resolve the problem, after the text information outputted by the voice recognition model is obtained, at least one processing of adding punctuations, correcting spelling errors, or correcting word order errors may be performed on the text information, to obtain more accurate demand information. For example, if the voice information inputted by the target object is “I want to know what is the weather like tomorrow, how should I query the weather condition of tomorrow?”, after the voice recognition is performed on the voice information by using the voice recognition model, the obtained text information may be “I want to know the weather what is like tomorrow how to query the wether condition of tomorrow”. The text information contains no punctuations for segmenting sentences, and the text information has problems such as spelling errors and word order errors, affecting the subsequent recognition accuracy of the text information. Therefore, punctuations may be added to the text information first, and the text information added with punctuations is “I want to know the weather what is like tomorrow, how to query the wether condition of tomorrow?”. Then, a spelling error “wether” in the text information is corrected to obtain a correct spelling “weather”, thereby obtaining text information “I want to know the weather what is like tomorrow, how to query the weather condition of tomorrow?”, in which the spelling error is corrected. Subsequently, a word order error “I want to know the weather what is like tomorrow” in the text information is corrected to obtain a correct word order “I want to know what is the weather like tomorrow”. Then, accurate demand information can be obtained as “I want to know what is the weather like tomorrow, how should I query the weather condition of tomorrow?”.

Thus, in the foregoing manner, voice recognition is performed on voice information inputted by a target object to obtain text information, and corresponding adjustment and error correction processing is performed on the text information, to ensure that the ultimately obtained text information accurately corresponds to the demand information of the target object, and correspondingly ensure the accuracy of subsequent instruction recognition on the demand information.

In an embodiment, when the pre-trained voice recognition model is invoked to perform voice recognition on the voice information to obtain text information, interference information such as ambient noise may be introduced when the voice information inputted by the target object is received, and the voice information inputted by the target object may be long voice, all these situations affect the voice recognition effect of the voice recognition model. To improve the voice recognition accuracy of the voice recognition model, when the pre-trained voice recognition model is invoked to perform the voice recognition on the voice information, at least one processing of noise removal and voice segmentation may be first performed on the voice information, to obtain preprocessed voice information. Then, a voice feature extraction model is invoked to perform voice feature extraction on the preprocessed voice information, to obtain voice feature information. Subsequently, the pre-trained voice recognition model is invoked to perform the voice recognition on the voice feature information, to obtain text information.

Noise removal is performed on the voice information to filter out interference information such as ambient noise that is introduced to the voice information, thereby improving the purity of the voice information. Voice segmentation is performed on the voice information, so that a long voice inputted by the target object can be segmented into a plurality of short voices, reducing the processing difficulty of subsequent voice feature extraction performed by the voice feature extraction model, thereby further improving the accuracy and efficiency of voice feature extraction.

In an embodiment, a voice feature extraction model is invoked to perform voice feature extraction on the preprocessed voice information, so as to convert the preprocessed voice information into voice feature information in a digital signal form (for example, an audio feature vector), so that a voice recognition model can subsequently conveniently perform more accurate recognition on the voice feature information. The voice feature extraction model may be a trained deep neural network model, a convolutional neural network model, or the like, or may be a mathematical model having voice feature extraction capability. Proper selection may be made according to a practical application situation, which is not specifically limited herein. For example, when the voice feature extraction model is a mathematical model having voice feature extraction capability, the voice feature extraction model may be a mathematical model capable of performing Mel frequency cepstral coefficients (MFCCs) processing on the preprocessed voice information, a mathematical model capable of performing discrete wavelet transform (DWT) processing on the preprocessed voice information, or a mathematical model capable of performing perceptual linear prediction (PLP) processing on the preprocessed voice information. This is not specifically limited herein. The Mel frequency cepstral coefficients processing is to obtain a Mel frequency cepstral coefficient from the preprocessed voice information. The Mel frequency cepstral coefficient is a common voice feature, and may be configured for representing a spectrum feature of a voice signal. The Mel frequency cepstral coefficient has a good human perceptual attribute, and can effectively extract a key feature of a voice signal. The discrete wavelet transform processing is a signal processing method based on wavelet analysis, and may be configured for performing feature extraction and denoising on a voice signal. The perceptual linear prediction processing is a voice feature extraction method. The perceptual linear prediction processing is based on the way human ears perceives sound, and can effectively extract important features of a voice signal in consideration of physiological and psychological features of the voice signal.

In an embodiment, the voice feature extraction model may alternatively be a mathematical model that performs combined Mel frequency cepstral coefficients processing and perceptual linear prediction processing on the preprocessed voice information. In this case, when the voice feature extraction model is invoked to perform voice feature extraction on the preprocessed voice information, Mel frequency cepstral coefficients processing and perceptual linear prediction processing may be separately performed on the preprocessed voice information first, to obtain a Mel frequency cepstral coefficient and a perceptual linear prediction feature parameter of the preprocessed voice information, and then an average value of the Mel frequency cepstral coefficient and the perceptual linear prediction feature parameter of the preprocessed voice information is calculated, thereby obtaining the voice feature information of the preprocessed voice information.

When the voice feature extraction model is invoked to perform Mel frequency cepstral coefficients processing on the preprocessed voice information, fast Fourier transform may be first performed on a time-domain signal of the preprocessed voice information, to obtain a frequency-domain signal of the preprocessed voice information; then, a logarithmic operation is performed on the frequency-domain signal of the preprocessed voice information, to obtain a logarithm spectrum of the preprocessed voice information; and then, discrete cosine transform is performed on the logarithm spectrum of the preprocessed voice information, to obtain a Mel frequency cepstral coefficient of the preprocessed voice information. When the voice feature extraction model is invoked to perform perceptual linear prediction processing on the preprocessed voice information, fast Fourier transform may be first performed on a time-domain signal of the preprocessed voice information, to obtain a frequency-domain signal of the preprocessed voice information; then, pre-emphasis and strength-loudness conversion are performed on the frequency-domain signal of the preprocessed voice information, to obtain loudness feature information of the preprocessed voice information; and then, inverse Fourier transform and linear prediction are performed on the loudness feature information of the preprocessed voice information, to obtain a perceptual linear prediction feature parameter of the preprocessed voice information. Mel frequency cepstral coefficients processing and perceptual linear prediction processing are separately performed on the preprocessed voice information to obtain corresponding processing results, then average calculation is performed on the two processing results to obtain an average value of the two processing results, and the average value is used as the voice feature information. This can better improve the accuracy of voice feature extraction of the preprocessed voice information, thereby facilitating subsequent accurate voice recognition performed by a voice recognition model on the voice feature information, and improving the accuracy of voice recognition performed by the voice recognition model on the voice information inputted by the target object.

Operation 320: Execute at least one round of target operation until a candidate execution instruction passing executability verification is obtained; in the first round of target operation, invoke a language model to perform instruction recognition on the demand information according to preset guidance prompt information, to obtain a candidate execution instruction of the first round of target operation, and perform the executability verification on the candidate execution instruction of the first round of target operation to determine whether the candidate execution instruction of the first round of target operation passes the executability verification; and in an i^{th} round of target operation, invoke the language model to perform the instruction recognition on the demand information according to a candidate execution instruction of an (i−1)^{th} round of target operation and the guidance prompt information, to obtain a candidate execution instruction of the i^{th} round of target operation, and perform the executability verification on the candidate execution instruction of the i^{th} round of target operation to determine whether the candidate execution instruction of the i^{th} round of target operation passes the executability verification, i being an integer greater than 1.

In this embodiment, the target operation refers to an operation of invoking the language model to perform instruction recognition on a requirement to obtain a candidate execution instruction and performing executability verification on the candidate execution instruction. In a practical application, the terminal may execute one or more rounds of target operations until a candidate execution instruction passing the executability verification is obtained. To be specific, if a candidate execution instruction passing the executability verification is obtained after the terminal executes one round of target operation, the terminal does not need to continue to execute the target operation; and if no candidate execution instruction passing the executability verification after the terminal executes one or more rounds of target operations, the terminal needs to continue to execute the target operation until a candidate execution instruction passing the executability verification is obtained.

In an embodiment, after the demand information of the target object is obtained, the language model may be invoked to perform the instruction recognition on the demand information according to the preset guidance prompt information, to obtain the candidate execution instruction, so that in subsequent operations, the terminal may automatically execute a corresponding operation task according to the candidate execution instruction, to avoid repeated interaction with the target object, thereby improving the efficiency of interaction between the target object and the terminal.

In an embodiment, a language model configured to perform the instruction recognition on the demand information according to the guidance prompt information may be an LLM model, an NLU model, or the like. Proper selection may be made according to a practical application situation, which is not specifically limited herein.

In an embodiment, the language model configured to perform the instruction recognition on the demand information according to the guidance prompt information may be deployed in a cloud server in communication connection with the terminal, or may be deployed in the terminal. This is not specifically limited herein. For example, when the terminal has a relatively small storage space and relatively low processing capability, the language model may be deployed in a cloud server in communication connection with the terminal. In this way, a storage space requirement and a processing capability requirement on the terminal can be reduced, thereby improving the general applicability of the instruction execution method based on a language model in this embodiment. For another example, when the terminal has a relatively large storage space and relatively high processing capability, the language model may be deployed in the terminal. In this way, the language model may be directly invoked in the terminal to perform the instruction recognition on the demand information, reducing the time consumption of interaction between the terminal and the cloud server, thereby improving the efficiency of responding to the demand information.

In an embodiment, when the language model is invoked to perform the instruction recognition on the demand information according to the preset guidance prompt information to obtain the candidate execution instruction, model-invoking request information may be generated according to the demand information and the preset guidance prompt information, then the model-invoking request information is sent to an invoking interface of the language model, and the language model is invoked to perform the instruction recognition on the demand information according to the guidance prompt information, to obtain the candidate execution instruction.

In an embodiment, when the language model is deployed in the cloud server, the terminal may generate model-invoking request information in a hyper text transfer protocol (HTTP) message format according to the demand information and the preset guidance prompt information. The demand information and the guidance prompt information fill a message part of the HTTP message. Then, the terminal sends the model-invoking request information in the HTTP message format to the language model through the invoking interface of the language model. After the language model receives the model-invoking request information through the invoking interface, the language model first parses the model-invoking request information in the HTTP message format, extracts the demand information and the guidance prompt information from the message part of the HTTP message, and then performs the instruction recognition on the demand information according to the guidance prompt information, to obtain the candidate execution instruction. After the language model obtains the candidate execution instruction through recognition, the language model returns the candidate execution instruction to the terminal through an HTTP response message.

In another embodiment, when the language model is deployed in the terminal, the terminal may generate, according to the demand information and the preset guidance prompt information, model-invoking request information that is in a signal format for transmission between modules in the terminal, and then send, by using an artificial intelligence interaction module in the terminal, the model-invoking request information to the invoking interface of the language model deployed in the terminal, so that the model-invoking request information is transmitted to the language model through the invoking interface. After the language model receives the model-invoking request information through the invoking interface, the language model first parses the model-invoking request information, extracts the demand information and the guidance prompt information from the model-invoking request information, and then performs the instruction recognition on the demand information according to the guidance prompt information to obtain a candidate execution instruction. After the language model recognizes the candidate execution instruction, the language model returns the candidate execution instruction to the artificial intelligence interaction module of the terminal through the invoking interface.

Thus, in the foregoing manner, the model-invoking request information is generated according to the demand information and the guidance prompt information, and the language model is invoked through the model-invoking request information to perform the instruction recognition, thereby improving the standardization of an instruction recognition process.

In an embodiment, the guidance prompt information (Prompt) is a text segment or prompt information provided for starting the language model. The guidance prompt information may be a word, a phrase, a sentence, a paragraph, or an entire article. This is not specifically limited herein. After the language model receives the guidance prompt information, the language model may generate a complete text according to the guidance prompt information, and the language model may make the generated text conform to a subject, a tone, and a style of the guidance prompt information as much as possible. Therefore, the language model is invoked to perform the instruction recognition on the demand information according to the preset guidance prompt information, so that the language model can perform the instruction recognition on the demand information more accurately according to content in the guidance prompt information, improving the confidence level of the candidate execution instruction obtained through recognition, thereby further obtaining a candidate execution instruction having a higher matching degree with the demand information.

In an embodiment, the guidance prompt information may be composed of a plurality of pieces of instruction prompt information, and each piece of instruction prompt information includes two parts, namely, a question prompt information part and answer prompt information part. For each piece of instruction prompt information, an application scenario of a current instruction and a corresponding question description are described in detail in the question prompt information part, which may be configured for instructing the language model to perform semantic recognition on question content in the application scenario of the current instruction; and an instruction message structure body (including an instruction name, an instruction parameter, and the like) of the current instruction and corresponding instruction explanations are described in detail in the answer prompt information part, which may be configured for instructing the language model to output corresponding answer content in the application scenario of the current instruction.

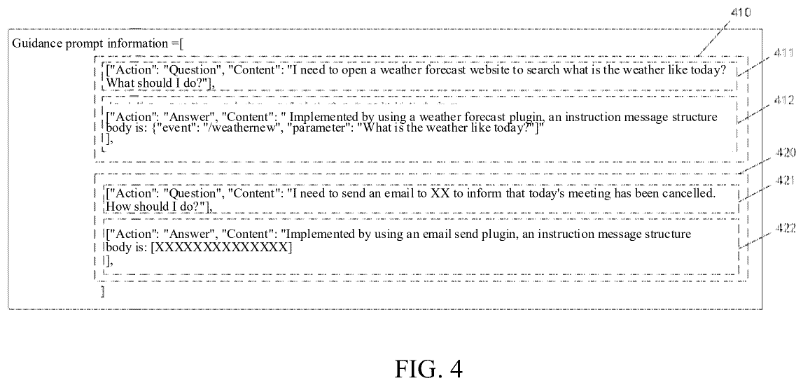

Referring to FIG. 4, FIG. 4 exemplarily provides structural content of the guidance prompt information. In FIG. 4, the guidance prompt information includes first instruction prompt information 410 and second instruction prompt information 420. The first instruction prompt information 410 includes a first question prompt information part 411 and a first answer prompt information part 412 that match each other. The second instruction prompt information 420 includes a second question prompt information part 421 and a second answer prompt information part 422 that match each other. Both the first question prompt information part 411 and the second question prompt information part 421 include a question action prompt description and corresponding question content. For example, in the first question prompt information part 411, the question action prompt description is “Action”: “Question”, which corresponds to question content “Content”: “I need to open a weather forecast web page to search for what is the weather like today? What should I do?”. Both the first answer prompt information part 412 and the second answer prompt information part 422 include an answer action prompt description and corresponding answer content. For example, in the first answer prompt information part 412, the answer action prompt description is “Action”: “Answer”, which corresponds to answer content “Content”: “Implemented by using a weather forecast plugin, an instruction message structure body is: {“event”: “/weathernew”, “parameter”: “What is the weather like today?”}”, where event refers to a name of the plugin, and parameter refers to a script parameter.

The language model is invoked to learn the question prompt information part and the answer prompt information part in each piece of guidance prompt information, so that the accuracy of performing instruction recognition on the demand information of the target object by the language model can be improved, and thus a candidate execution instruction obtained through recognition can more accurately meet an application scenario in which the target object sends the demand information.

In an embodiment, the guidance prompt information may include prompt information of various different types of instructions. Each instruction corresponds to a corresponding application scenario and use manner. For example, as shown in Table 1 below, Table 1 exemplarily provides applications corresponding to the various instructions and examples of classification of the applications.

TABLE 1

| Classification | | Classification | | Classification | |
|---|---|---|---|---|---|
| of | Name of | of | Name of | of | Name of |
| instructions | instructions | instructions | instructions | instructions | instructions |
| Search | Search via | Message | Send message via | Application | Schedule online |
| instruction | search engine A | instruction | instant messaging | instruction | meeting |
| | | | software A | | |
| | Search via | | Send voice message | | Modify online |
| | search engine B | | via instant | | conference |
| | | | messaging software A | | |
| | Search via | | Send message via | | Check social |
| | search engine C | | instant messaging | | platform |
| | | | software B | | information |
| | Search via | | Send voice message | | Check hot search |
| | search engine D | | via instant | | topics on social |
| | | | messaging software B | | network service |
| | | | | | platform |
| | Search via | | Send message via | | Check information |
| | search engine E | | instant messaging | | about e-commerce |
| | | | software C | | platform A |
| | Search via | | Send voice message | | Check news on |
| | search engine F | | via instant | | news engine A |
| | | | messaging software C | | |
| | Search via | | Send message via | | Check news on |
| | search engine G | | instant messaging | | news engine B |
| | | | software D | | |
| | | | Send voice message | | Check news on |
| | | | via instant | | news engine C |
| | | | messaging software D | | |
| | | | Send voice message | | Check videos on |
| | | | over telephone | | multimedia |
| | | | | | social platform |
| | | | Send SMS message | | Browse website |
| | | | Check email | | Check text |
| | | | message | | document |
| | | | Send email | | Check table |
| | | | | | document |
| | | | | | Check graphic |
| | | | | | presentation |
| | | | | | document |

It can be seen from the content in Table 1 that the guidance prompt information provided in this embodiment includes prompt information of various different types of instructions such as a search instruction, a message instruction, and an application instruction, and further includes an application scenario and a use manner corresponding to these instructions. For example, a search is performed via a search engine, a message or a voice message is sent via instant messaging software, and news is checked on a news engine. Therefore, when the language model performs the instruction recognition on the demand information according to the guidance prompt information, more accurate instruction recognition can be performed on the demand information of the target object, thereby effectively improving the confidence level of a candidate execution instruction obtained through recognition, and obtaining a candidate execution instruction having a higher matching degree with the demand information.

In an embodiment, the language model configured to perform the instruction recognition on the demand information according to the guidance prompt information is a trained natural language processing model based on a neural network. Therefore, when the language model is invoked to perform the instruction recognition on the demand information according to the guidance prompt information, the execution instruction corresponding to the demand information can be effectively recognized. A process of training the language model may include the following four operations: (1) training data preparation; (2) dictionary establishment; (3) model construction; and (4) model training.

In the training data preparation operation, public sample data sets may be downloaded through a network in advance, or a natural language generation model is used to generate sample data sets. These sample data sets may include various different types of natural linguistic data such as web page content, news content, or novel content. Then, the sample data sets and preset guidance prompt information are constructed into training sample data, and preprocessing such as cleaning, tokenization, and stop word removal is performed on the training sample data, to obtain a training sample set for training a language model.

In the dictionary establishment operation, vocabulary appearing in all text information of the training sample sets may be statistically collected and counted to establish a dictionary, and then a corresponding unique number is generated for each word in the dictionary, so that the language model may be trained by using the dictionary in subsequent operations.

In the model construction operation, a neural network may be used to construct a language model. For example, a recurrent neural network may be used to construct a language model. A recurrent neural network has a memory capability, and can memorize a previous input, thereby affecting a subsequent output. During construction of a language model, parameters may be set for the language model. For example, parameters such as a quantity of hidden layers and a learning rate may be set for the language model. In an embodiment, a quantity of hidden layers of the language model may be set to 12. To be specific, the language model may include 12 hidden layers. In addition, a learning rate of the language model may be set to 50%. This is not specifically limited herein.

In the model training operation, the training sample sets processed in the foregoing operation are inputted to the language model for training. During training, the parameters of the language model are continuously adjusted to minimize an error between a prediction result and an actual result (that is, a label) of the language model. When the error between the prediction result and the actual result of the language model is less than a preset error threshold, or a quantity of times of iterative training on the language model reaches a preset quantity threshold, it may be considered that the training on the language model is completed. Once the training on the language model is completed, the language model may be used to perform the instruction recognition on the demand information of the target object.

In an embodiment, in a process of training the language model, processing methods such as dropout or batch normalization (BN) may be used to improve the training effect of the language model. In the process of training the language model, dropout can inactivate some nodes in the language model, which not only can simplify the structure of the language model during training, but also can prevent the weight of a node from being excessively large during training of the language model, thereby reducing the overfitting of the language model. In addition, in the process of training the language model, by the use of batch normalization, an intermediate output of the language model can be adjusted by using a small batch of mean values and variances during training, so that all outputs between network layers in the language model can conform to a Gaussian distribution with same mean values and variances, thereby making data more stable. Regardless of how a parameter of a hidden layer in the language model changes, it can be determined that a mean value and a variance of output data of a previous layer of network are known and fixed. Therefore, problems such as slow training and a small learning rate that are caused by constant changes of data distribution can be effectively resolved.

In an embodiment, after the language model is invoked to perform the instruction recognition on the demand information according to the guidance prompt information to obtain a candidate execution instruction, the candidate execution instruction is not necessarily a legal executable execution instruction. If the candidate execution instruction is not a legal executable execution instruction, subsequently the terminal cannot be controlled, according to the candidate execution instruction, to execute the operation task corresponding to the demand information, causing problems such as low efficiency of interaction between the target object and the terminal and poor user experience.

To improve the efficiency of interaction between the target object and the terminal and improve the user experience, after the candidate execution instruction is obtained, executability verification may be first performed on the candidate execution instruction to obtain an executability verification result, and then whether the candidate execution instruction passes the executability verification is determined according to the executability verification result. If the executability verification result is that the candidate execution instruction fails to pass the executability verification, it indicates that the candidate execution instruction recognized by the language model in this round of target operation is inaccurate and is not a legal executable execution instruction. In this case, a next round of target operation may be started. To be specific, the language model is invoked to re-perform the instruction recognition on the demand information according to the candidate execution instruction in the previous target operation and the guidance prompt information to obtain a candidate execution instruction in the current round of target operation, then re-perform the executability verification on the candidate execution instruction to obtain an executability verification result, and then determine, according to the executability verification result, whether the candidate execution instruction passes the executability verification. This is repeated until the obtained candidate execution instruction passes the executability verification.

Since the candidate execution instruction passing the executability verification is obtained by invoking the language model for a plurality of times to perform the instruction recognition on the demand information according to the guidance prompt information and the candidate execution instruction in the previous round of target operation, the confidence level of the candidate execution instruction can be further improved. In addition, since a process of invoking the language model to re-perform the instruction recognition on the demand information is determined based on a specific situation of an executability verification result, the process of invoking the language model to re-perform the instruction recognition on the demand information is automatically completed, the target object does not need any additional operation, and the target object does not need repeated interaction with the terminal. Therefore, the efficiency of interaction between the target object and the terminal can be improved, simplifying the use of the target object, thereby improving the use experience of the target object.

In an embodiment, when the language model is invoked to re-perform the instruction recognition on the demand information according to the candidate execution instruction in the previous target operation and the guidance prompt information, model-invoking request information may be re-generated according to the candidate execution instruction obtained through recognition, the demand information of the target object, and the preset guidance prompt information, then the re-generated model-invoking request information is sent to an invoking interface of the language model, and the language model is invoked to re-perform the instruction recognition on the demand information according to the candidate execution instruction and the guidance prompt information.

When the language model is invoked to re-perform the instruction recognition on the demand information for a plurality of times, the model-invoking request information may be re-generated according to a plurality of candidate execution instructions previously obtained through recognition, the demand information, and the guidance prompt information, and then the re-generated model-invoking request information is sent to the invoking interface of the language model, so that the language model is invoked to re-perform the instruction recognition on the demand information according to the plurality of candidate execution instructions previously obtained through recognition and the guidance prompt information, thereby increasing the confidence level of the candidate execution instruction newly obtained through recognition according to the plurality of candidate execution instructions previously obtained through recognition. For example, assuming that for demand information A, the language model is invoked to perform the instruction recognition on the demand information A for three times to obtain three previous candidate execution instructions, when the language model is invoked to perform the instruction recognition on the demand information A for the fourth time, the model-invoking request information is regenerated according to the three candidate execution instructions obtained through the first three times of recognition, the demand information A, and the preset guidance prompt information, then the regenerated model-invoking request information is sent to the invoking interface of the language model, and then the language model is invoked to re-perform the instruction recognition on the demand information A according to the three candidate execution instructions obtained through the first three times of recognition and the guidance prompt information.

In an embodiment, when executability verification is performed on the candidate execution instruction to obtain an executability verification result, an instruction functional function in the candidate execution instruction may be first replaced with a target empty function, and a function result of the target empty function may be always true, to obtain a to-be-verified execution instruction; then, an instruction execution engine is invoked to perform simulative execution on the to-be-verified execution instruction, to obtain a simulative execution result; and then, an executability verification result is obtained according to the simulative execution result, that is, whether the candidate execution instruction passes the executability verification is determined.

When the executability verification is performed on the candidate execution instruction, since operations corresponding to the instruction functional function in the candidate execution instruction may be relatively complex, directly invoking the instruction execution engine to perform the simulative execution on the candidate execution instruction may cause a problem of a relatively long execution time, thereby affecting the efficiency of performing the executability verification on the candidate execution instruction. To reduce the time consumption for performing the executability verification on the candidate execution instruction so as to improve the efficiency of performing the executability verification on the candidate execution instruction, the instruction functional function in the candidate execution instruction may be replaced with an empty function whose function result is always true, to obtain the to-be-verified execution instruction. In this way, when the instruction execution engine is invoked to perform the simulative execution on the to-be-verified execution instruction, the executability of the to-be-verified execution instruction may be verified relatively quickly, thereby improving the efficiency of performing the executability verification on the candidate execution instruction.

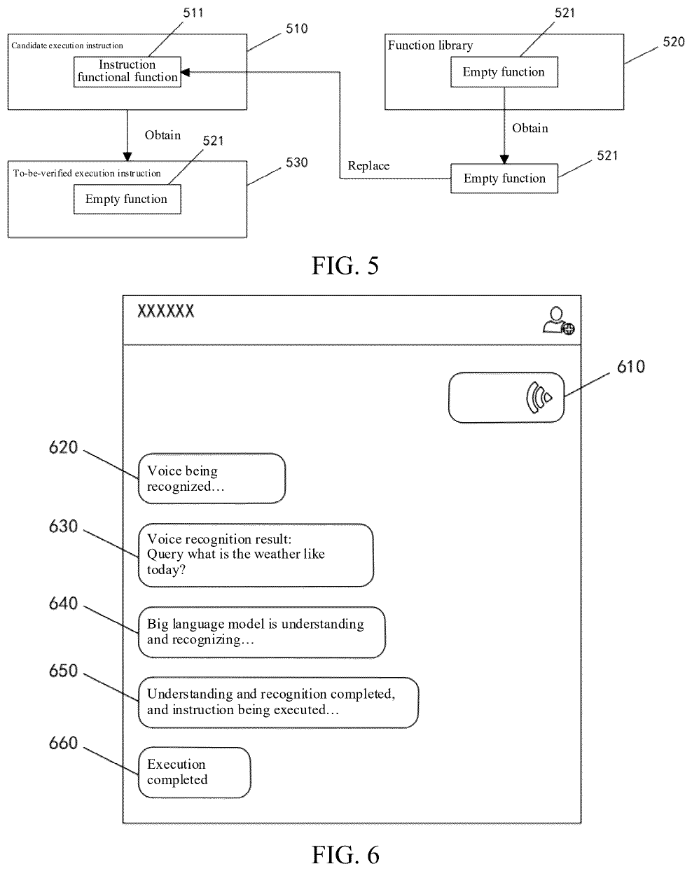

Referring to FIG. 5, FIG. 5 exemplarily provides a process of replacing an instruction functional function in a candidate execution instruction with an empty function whose function result is always true. In FIG. 5, assuming that the candidate execution instruction 510 includes an instruction functional function 511, the candidate execution instruction 510 may be first parsed to determine the instruction functional function 511 in the candidate execution instruction 510, then an empty function 521 whose function result is always true is obtained from a preset function library 520, and then the instruction functional function 511 in the candidate execution instruction 510 is replaced with the empty function 521, to obtain a to-be-verified execution instruction 530 including the empty function 521 whose function result is always true.

In an embodiment, before the executability verification is performed on the candidate execution instruction, format verification may be performed on the candidate execution instruction first. If the format of the candidate execution instruction is consistent with the instruction message structure body in the guidance prompt information, it indicates that the candidate execution instruction passes the format verification, the instruction execution engine can perform the simulative execution on the candidate execution instruction, and therefore the executability verification can be performed. If the format of the candidate execution instruction is inconsistent with the instruction message structure body in the guidance prompt information, it indicates that the candidate execution instruction fails to pass the format verification, and the instruction execution engine cannot recognize the candidate execution instruction. Therefore, the simulative execution cannot be performed on the candidate execution instruction, and thus the executability verification cannot be performed. To be specific, the candidate execution instruction failing to pass the format verification does not require the executability verification, and it is directly considered that the candidate execution instruction fails to pass the executability verification, thereby improving the efficiency of performing the executability verification on the candidate execution instruction. By performing the format verification on the candidate execution instruction first, a candidate execution instruction failing to pass the format verification may be directly determined as a candidate execution instruction failing to pass the executability verification, thereby reducing the time consumption for performing the executability verification on the candidate execution instruction failing to pass the format verification, and therefore effectively improving the efficiency of performing the executability verification on the candidate execution instruction.

In an embodiment, when the executability verification result is obtained according to the simulative execution result, if the simulative execution result indicates successful execution of the to-be-verified execution instruction, it indicates that an empty function whose function result is always true in the to-be-verified execution instruction can be accurately recognized and executed. Then, if the empty function in the to-be-verified execution instruction is replaced with the instruction functional function to restore the to-be-verified execution instruction to the original candidate execution instruction, the instruction functional function in the candidate execution instruction may also be accurately recognized and executed. Therefore, an executability verification result indicating that the candidate execution instruction passes the executability verification may be obtained. If the simulative execution result indicates unsuccessful execution of the to-be-verified execution instruction, it indicates that an empty function whose function result in the to-be-verified execution instruction is always true cannot be accurately recognized and cannot be executed. Then, if the empty function in the to-be-verified execution instruction is replaced with the instruction functional function to restore the to-be-verified execution instruction to the original candidate execution instruction, the instruction functional function in the candidate execution instruction also cannot be accurately recognized and cannot be executed. Therefore, an executability verification result indicating that the candidate execution instruction fails to pass the executability verification may be obtained.

Thus, in the foregoing manner, whether the candidate execution instruction passes the executability verification is determined according to the simulative execution result obtained by executing the to-be-verified execution instruction, which can ensure the accuracy and reliability of the determined executability verification result, and ensure that the executability verification result is efficiently determined.

In an embodiment, if an executability verification result obtained by performing the executability verification on the candidate execution instruction for the first time is that the candidate execution instruction passes the executability verification, it indicates that the candidate execution instruction is an execution instruction matching the demand information of the target object. Thus, there is no need to invoke the language model to re-perform the instruction recognition on the demand information, and the terminal may be directly controlled, according to the candidate execution instruction, to execute the operation task corresponding to the demand information.

Operation 330: Use the candidate execution instruction passing the executability verification as a target execution instruction, and control, according to the target execution instruction, a terminal to execute an operation task corresponding to the demand information.

In an embodiment, when a candidate execution instruction passing the executability verification is obtained, the candidate execution instruction passing the executability verification may first be used as a target execution instruction, and then the terminal is controlled, according to the target execution instruction, to execute the operation task corresponding to the demand information, to satisfy a use requirement of the target object. Since the processes from obtaining the candidate execution instruction passing the executability verification to controlling, according to the target execution instruction, the terminal to execute the operation task corresponding to the demand information are all automatically executed by the terminal, the target object does not need any additional operation, and the target object does not need repeated interaction. Therefore, the efficiency of interaction between the target object and the terminal can be effectively improved, simplifying operations of the target object, thereby effectively improving the use experience of the target object.

In an embodiment, when the terminal is controlled, according to the target execution instruction, to execute the operation task corresponding to the demand information, a corresponding instruction execution code may be obtained first according to the target execution instruction, and then the instruction execution code is run in a virtual environment, to control the terminal to execute the operation task corresponding to the demand information. Each target execution instruction has a corresponding instruction execution code, and a process of each operation of executing the target execution instruction is recorded in the instruction execution code. Therefore, the instruction execution code corresponding to the target execution instruction is obtained first, and then the instruction execution code is run in the virtual environment, to simulate the target object controlling the terminal to execute the operation task corresponding to the demand information.

Thus, in the foregoing manner, accurate and reliable execution of the operation task can be ensured by obtaining the instruction execution code corresponding to the target execution instruction and running the instruction execution code to control the terminal to execute the operation task corresponding to the demand information.

In an embodiment, to implement simultaneous concurrent execution of different execution instructions, after a plurality of target execution instructions are obtained and instruction execution codes corresponding to the target execution instructions are invoked, a plurality of virtual environments (for example, a virtual image of an operating system with a desktop) are simultaneously started, and instruction execution codes of different target execution instructions are simultaneously executed in different virtual environments, thereby implementing concurrent execution of different operation tasks by means of simultaneous running of a plurality of operating system images.

In an embodiment, when the instruction execution code is run in the virtual environment to control the terminal to execute the operation task corresponding to the demand information, an instruction execution process may be first run in the virtual environment, and then the instruction execution process is invoked to run the instruction execution code, to control the terminal to execute the operation task corresponding to the demand information.

When the instruction execution code is run in the virtual environment, a corresponding instruction execution process may be started in an operating system running in each virtual environment, and the instruction execution process may be used for automatically performing a control operation on the terminal. For example, assuming that the terminal is a computer to which a mouse and a keyboard are connected, the instruction execution process may be used for automatically performing a control operation on the computer through the mouse and the keyboard. The operation task corresponding to the demand information, which the terminal is controlled to execute, may be various operation tasks which the terminal is controlled to execute. For example, they may include various different types of operation tasks such as starting an application program, inputting a text, clicking a button, and dragging a window.

In an embodiment, the instruction execution code invoked according to the target execution instruction may be used for implementing different operation tasks such as starting an application program, inputting a text, clicking a button, or dragging a window. Referring to Table 2, Table 2 exemplarily provides various instruction execution codes that can implement different functions.

TABLE 2

| Execution code | Parameter | Description |
|---|---|---|
| getSize | None | Obtain current screen resolution |
| getLocation | None | Obtain coordinates of current |
| | | operation cursor |
| moveTo | source: Initial coordinates | Move operation cursor between two |
| | target: Target coordinates | coordinates |
| | duration: Time consumption for | |
| | movement | |
| click | clicks: Quantity of clicks | Perform click operation on current |
| | interval: Time interval | coordinates |
| | button: Key click position, left | |
| | middle right | |
| typeWrite | message: Input character | Input character at current coordinates |
| | interval: Input time interval | |
| keyDown | key: Name of pressed key of | Press a key position of keyboard |
| | keyboard | |
| keyUP | key: Name of released key of | Release a key position of keyboard |
| | keyboard | |
| locateOnScreen | image: Picture location | Location and size of image on screen |
| center | rect: Rectangular position | Obtain coordinates of center point of |
| | | rectangular object |

It can be seen from the content in Table 2 that the instruction execution code in this embodiment includes various instruction execution codes that can implement different functions, such as an instruction execution code that can obtain coordinates of an operation cursor, an instruction execution code that can move an operation cursor, an instruction execution code that can simulate a click operation, and an instruction execution code that can input a character. Therefore, when a corresponding instruction execution code is obtained according to a target execution instruction, control of a target object by a terminal can be effectively simulated, to execute an operation task corresponding to demand information. In an embodiment, the instruction execution code in this embodiment may invoke an application programming interface of an operating system to obtain data and simulate a corresponding operation action.

In an embodiment, when the terminal includes a display module configured to display an operation cursor, when the terminal is controlled to execute the operation task corresponding to the demand information, initial coordinates of the operation cursor may be first obtained, then target coordinates for executing the operation task corresponding to the demand information are determined, then the operation cursor is controlled to move from the initial coordinates to the target coordinates, and the terminal is controlled to execute the operation task corresponding to the demand information at the target coordinates.

When the initial coordinates of the operation cursor are obtained, the application programming interface of the operating system may be first invoked to obtain screen resolution of the display module, and then the initial coordinates of the operation cursor are obtained according to the screen resolution. For example, assuming that the screen resolution of the display module is 1920*1080, and the operation cursor is located at a central position of the screen of the display module, it may be determined that initial coordinates of the operation cursor on the screen of the display module are (960, 540). Since execution of the operation task corresponding to the demand information is automatically implemented by using the terminal to simulate an operation mode of the target object, the entire process does not need participation of the target object, and does not need the target object to perform any additional operation. Therefore, use of the terminal by the target object can be effectively simplified, thereby improving the use experience of the target object. In addition, a process of executing the operation task corresponding to the demand information by the terminal can be visualized by controlling the movement of the operation cursor, so that the target object can learn an execution process of the operation task. The display module may be integrated into a display screen of the terminal, or may be an external display device of the terminal. This is not specifically limited herein. For example, when the terminal is a smartphone, the display module may be a display screen of the smartphone. When the terminal is a computer, the display module may be an external display of the computer.

The process of controlling the terminal to execute the operation task corresponding to the demand information is specifically described below by using an example.

For example, assuming that the demand information of the target object is querying a weather condition of today, the operation task corresponding to the demand information may be querying a weather condition of today through a browser. In this case, an instruction execution process run in the virtual environment may run a getSize instruction execution code, and a screen width and a screen height of the terminal are obtained according to the getSize instruction execution code. In this case, the getSize instruction execution code returns a piece of tuple data. The tuple data may be, for example, (1920, 1080), indicating the screen resolution of the terminal. Then, the instruction execution process may run a getLocation instruction execution code, and current coordinates (a, b) of the operation cursor on the screen of the terminal and target coordinates (x, y) of an icon of a browser application program on the screen of the terminal are obtained according to the getLocation instruction execution code. Subsequently, the instruction execution process may run a reveTo instruction execution code to make the operation cursor move from the current coordinates (a, b) to the target coordinates (x, y) at a certain speed, run a click instruction execution code, simulate a click operation performed by the target object on the icon of the browser application program (for example, simulate an operation of double-clicking a left mouse button performed by the target object on the icon of the browser application program), and start the browser application program. After the browser application program is started, the instruction execution process may run the getSize instruction execution code, and obtain coordinates (h, i) of a search input box on a browser page. Then, the instruction execution process may run the reveTo instruction execution code again to make the operation cursor move from the target coordinates (x, y) to the coordinates (h, i) of the search input box at a certain speed, and run the click instruction execution code again, to simulate a click operation performed by the target object on the search input box (for example, simulate an operation of clicking a left mouse button by the target object on the search input box), so that the operation cursor is positioned in the search input box. Subsequently, the instruction execution process may run a typeWrite instruction execution code, and simulate an input operation of the target object in the search input box, inputting text information “What is the weather like today?” in the search input box, so as to obtain a weather condition of today by querying through a browser. Since execution of the operation task corresponding to the demand information is automatically implemented by using the terminal to simulate an operation mode of the target object, the entire process does not need participation of the target object, and does not need the target object to perform any complex additional operation. Therefore, the use of the terminal by the target object can be effectively simplified, thereby improving the use experience of the target object.

In this embodiment, by the instruction execution method based on a language model including the foregoing operation 310 to operation 330, when the demand information of the target object is received, at least one round of target operation is executed, until the candidate execution instruction passing executability verification is obtained. In the first round of target operation, the language model is first invoked to perform the instruction recognition on the demand information according to the preset guidance prompt information, to obtain the candidate execution instruction of the first round of target operation. The candidate execution instruction is obtained by performing, by the language model, the instruction recognition on the demand information according to the guidance prompt information. Therefore, the confidence level of the candidate execution instruction can be increased, thereby helping to obtain a candidate execution instruction having a higher matching degree with the demand information. Then, the executability verification is performed on the candidate execution instruction of the first round of target operation to determine whether the candidate execution instruction passes the executability verification; and if the candidate execution instruction fails to pass the executability verification, it indicates that the candidate execution instruction obtained by the current language model through recognition is inaccurate. In this case, a next round of target operation is performed. In the next round of target operation, the language model is invoked to re-perform the instruction recognition on the demand information according to the candidate execution instruction in the previous target operation and the guidance prompt information, to obtain a candidate execution instruction of this round of target operation, and then the executability verification is re-performed on this candidate execution instruction to determine whether this candidate execution instruction passes the executability verification. Several rounds of target operations are repeatedly performed in this way until a candidate execution instruction passing the executability verification is obtained. In addition, after the candidate execution instruction passing the executability verification is obtained, the candidate execution instruction is used as the target execution instruction, and the terminal is controlled, according to the target execution instruction, to execute the operation task corresponding to the demand information. The candidate execution instruction passing the executability verification is obtained by invoking the language model to perform the instruction recognition on the demand information according to the guidance prompt information and the previous candidate execution instruction for many times. Therefore, the confidence level of the candidate execution instruction can be ensured. Moreover, this process is automatically completed, the target object does not need any additional operation, and the target object does not need repeated interaction. Therefore, the efficiency of interaction between the target object and the terminal can be improved, simplifying the use of the target object, thereby improving the use experience of the target object.

An exemplary process of the instruction execution method based on a language model is described below by using a specific example.

Referring to FIG. 6, FIG. 6 is a schematic diagram of an interface that a user interacts with a terminal through an artificial intelligence interaction module. After the user enters voice information 610 to the terminal through an interactive interface of an artificial intelligence interaction module, the terminal first recognizes the voice information 610. To avoid displaying blank content while the user is waiting, the terminal may display first loading and waiting indication information 620 on the interactive interface, to prompt the user that the voice information 610 is being recognized. While recognizing the voice information 610, the terminal may first invoke a pre-trained voice recognition model to perform voice recognition on the voice information 610, to obtain text information, and then perform at least one processing of adding punctuations, correcting spelling errors, or correcting word order errors for the text information, to obtain demand information 630 of the user. At this point, the terminal completes the recognition of the voice information 610. The pre-trained voice recognition model is configured to convert an audio feature vector of voice information into text information. The voice recognition model may include models commonly used in the art, such as a hidden Markov model, a Gaussian mixture model, a deep neural network model, an n-gram language model, or another statistical model.

After the terminal obtains the demand information 630 of the user by completing the recognition of the voice information 610, the demand information 630 obtained through recognition may be displayed on the interactive interface. For example, assuming that the voice information 610 sent by the user is “Check what is the weather like today?”, the terminal, after accurately recognizing the voice information 610, may display demand information 630 whose content is “Check what is the weather like today?” on the interactive interface. After the terminal completes the recognition of the voice information 610, the terminal invokes the language model to perform instruction recognition on the content of the demand information 630 according to the guidance prompt information. In this case, to avoid displaying blank content while the user is waiting, the terminal may display second loading and waiting indication information 640 on the interactive interface, to prompt the user that the instruction recognition is being performed on the content of the demand information 630.

While invoking the language model to perform the instruction recognition on the content of the demand information 630 according to the guidance prompt information, the terminal may first generate model-invoking request information according to the guidance prompt information and the demand information 630, and then send the model-invoking request information to the invoking interface of the language model, to invoke the language model to perform the instruction recognition on the demand information 630 according to the guidance prompt information.

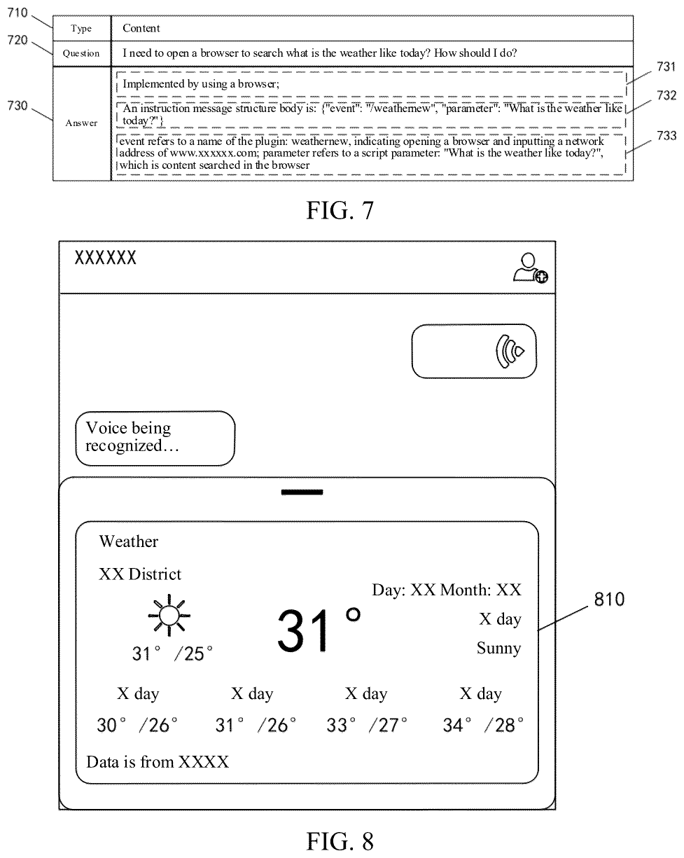

For the content structure of the guidance prompt information, reference may be made to FIG. 7. FIG. 7 exemplarily provides an example of the guidance prompt information. In FIG. 7, the guidance prompt information may include a type field 710, a question field 720, and an answer field 730. An information type of the guidance prompt information is recorded in the type field 710. For example, as shown in FIG. 7, the information type of the guidance prompt information is “Content”. Question content of the guidance prompt information is recorded in the question item 720. For example, as shown in FIG. 7, the question content of the guidance prompt information is “I need to open a browser to search for what the weather is like today? What should I do?”. Answer content of the guidance prompt information is recorded in the answer item 730. For example, as shown in FIG. 7, the answer content of the guidance prompt information includes an answer description 731, an instruction message structure body description 732, and an explanation description 733. The answer description 731 is “Implemented by using a browser plugin”, and the instruction message structure body description 732 is “The instruction message structure body is: {“event”: “/weathernew”, “parameter”: “What is the weather like today?”}”, and the explanation description 733 is “Event refers to a name of the plugin: weathernew, indicating opening a browser and entering www.xxxxxx.com; parameter refers to a script parameter: “What is the weather like today?”, which is content searched in the browser. During generation of the guidance prompt information, the information type of the guidance prompt information, the question content, and the answer content corresponding to the question content may be obtained first. Then, the type field 710 is filled with the information type of the guidance prompt information, the question field 720 is filled with the question content of the guidance prompt information, and the answer field 730 is filled with the answer content corresponding to the question content. At this point, the guidance prompt information may be obtained.

After the terminal invokes the language model to perform the instruction recognition on the demand information 630 according to the guidance prompt information to obtain the target execution instruction, the terminal may be further controlled, according to the target execution instruction, to execute the corresponding operation task. While the terminal is controlled to execute the corresponding operation task, third loading and waiting indication information 650 may be displayed on the interactive interface, to prompt the user that the operation task desired by the user is being executed. In addition, after the terminal completes the execution of the corresponding operation task, execution completion indication information 660 may be displayed on the interactive interface, to notify the user that the operation task corresponding to the voice information 610 is completed.

While invoking the language model to perform the instruction recognition on the demand information 630 according to the guidance prompt information, the terminal performs executability verification on a candidate execution instruction obtained through current recognition. If the candidate execution instruction obtained through current recognition fails to pass the executability verification, the terminal invokes the language model to re-perform the instruction recognition on the demand information 630 according to the candidate execution instruction and the guidance prompt information, to obtain a new candidate execution instruction, and then re-performs the executability verification on the new candidate execution instruction. The foregoing process is repeated in this way, until a candidate execution instruction passing the executability verification is obtained. In this case, the terminal uses the candidate execution instruction passing the executability verification as a target execution instruction.

While the terminal is performing executability verification on the candidate execution instruction obtained through current recognition, an instruction functional function in the candidate execution instruction may be first replaced with an empty function whose function result is always true, to obtain a to-be-verified execution instruction, then an instruction execution engine is invoked to perform simulative execution on the to-be-verified execution instruction, to obtain a simulative execution result, and then an executability verification result is obtained according to the simulative execution result. In addition, while the terminal is controlled, according to the target execution instruction, to execute the corresponding operation task, a corresponding instruction execution code may be obtained first according to the target execution instruction, then the instruction execution process is run in a virtual environment, and then an instruction execution process is invoked to run the instruction execution code, to control the terminal to execute the operation task corresponding to the demand information. In addition, after the terminal completes the execution of the corresponding operation task, an interactive interface shown in FIG. 8 is displayed. On the interactive interface shown in FIG. 8, an operation result after the corresponding operation task is executed may be displayed through a pop-up window 810, and a user may obtain desired requirement content according to the operation result displayed through the pop-up window 810. In addition, in another embodiment, an operation result after the corresponding operation task is completed may alternatively be displayed by means of page jump. This is not specifically limited herein.

In an embodiment, when the terminal is controlled, according to the target execution instruction, to execute the operation task corresponding to the demand information, the terminal may further create an execution record table including an execution instruction name entry, an instruction execution code entry, an execution status entry, and an execution result entry. The target execution instruction is recorded in the execution instruction name entry, and an instruction execution code corresponding to the target execution instruction is recorded in the instruction execution code entry. After the terminal is controlled to complete the execution of the operation task corresponding to the demand information, the terminal may update content of the execution status entry as “Completed” in the execution record table, and write a corresponding execution result into the execution result entry. An execution situation of the target execution instruction is recorded by creating the execution record table, so that the execution situation of the target execution instruction can be managed and controlled in real time, thereby facilitating automatic execution of the operation task corresponding to the demand information by the terminal.

In an embodiment, assuming that an instruction message structure body of a target execution instruction obtained through recognition is:
{“event”: “/weathernew”, “parameter”: “What is the weather like today?”},
where weathernew is plugin_name, that is, a name of a plugin, and different plugins have different instruction execution codes in a steps entry.

Therefore, when the terminal is controlled, according to the target execution instruction, to execute the operation task corresponding to the demand information, the terminal may create an execution record table in an instruction running database. The execution record table includes a plurality of pieces of entry content such as an execution instruction name entry, an instruction execution code entry, an execution status entry, and an execution result entry. Information such as process relationships among a plurality of target execution instructions and execution time can be recorded in the execution record table through these entries. Referring to Table 3, Table 3 exemplarily provides a specific structure of an execution record table.

TABLE 3

| id | event_id | plugin_name | status | start_at | end_at | steps | result |
|---|---|---|---|---|---|---|---|
| Operation | Execution | Name of | Complete | Start time | End time | Instruction | Execution |
| task | action | plugin | status | | | execution | result |
| identifier | identifier | | | | | code | |

In Table 3, content in the first row is an entry name, and content in the second row is entry content, where a plugin_name entry is an execution instruction name entry, a steps entry is an instruction execution code entry, a status entry is an execution status entry, and result is an execution result entry. In the execution record table, an instruction execution code in the steps entry may be obtained and loaded from a plugin execution code database according to a plugin name (that is, an execution instruction name) recorded in the plugin_name entry. In this way, when the terminal is controlled, according to the target execution instruction, to execute the operation task corresponding to the demand information, an instruction execution engine may perform execution step by step according to specific content of the instruction execution code in the steps entry, so as to control the terminal to execute the operation task corresponding to the demand information.

In an embodiment, all target execution instructions obtained through recognition based on a language model may have a unified standard instruction message structure body. To be specific, when outputting a candidate execution instruction obtained through recognition, the language model may output the candidate execution instruction in a form of a unified standard instruction message structure body. In this way, a unified standard of all operation tasks may be implemented by standardization of the instruction message structure body, so that running environments for executing the target execution instructions may be unified, enabling a multi-operation system image mode (that is, a plurality of virtual environments) to support concurrency of a plurality of operation tasks, thereby effectively reducing the costs for executing the plurality of operation tasks.

In an embodiment, during system operation, the terminal further generates a corresponding log file, and corresponding log information is recorded in the log file in detail, so that operation conditions of the terminal are managed and controlled according to the log information in the log file, thereby implementing daily fault dropping and status recording for terminal operation.

In an embodiment, the log information in the log file may include different log types. For example, the log information may include an error type, an alarm type, an information type, and a debugging type, and different types of log information may have different purposes. In addition, the log information in the log file may further include different log content. The log information in the log file may be classified into a configuration log, an alarm log, a background log, and the like according to different log content. Referring to Table 4 and Table 5, Table 4 exemplarily provides a description of different types of the log information, and Table 5 exemplarily provides a description of different content of the log information.

TABLE 4

| Log type | Description |
|---|---|
| Error type | An error log is a highest-level error record, indicating a serious fault occurs in a |
| | system that causes the system to fail to work normally. An error log needs close |
| | attention of an administrator to be resolved in time to ensure normal operation of a |
| | service system. |
| Alarm type | An alarm log is a low-level abnormality log, indicating that a system triggers an |
| | abnormal process during operation, but normal work of the system is not affected, |
| | and a service process in a subsequent stage can be normally executed. The alarm log |
| | needs sufficient attention of an administrator, and usually indicates that some risks |
| | exist in operation of the system, and operation faults may occur in the system. |
| Information | Usually, key information of a system is recorded in an information log, key |
| type | operation data during normal work of the system is kept in the information log, and |
| | an administrator needs to pay some attention to the information log during daily |
| | operation and maintenance work. |
| Debugging type | A debugging log is mainly a record of various types of detailed system information, |
| | plays a role of debugging a system, and includes various types of information such |
| | as detailed parameter information, debugging detail-related information, and |
| | operation return information. |

It can be seen from the content in Table 4 that when log information of an error type is recorded in a log file, an administrator needs to pay close attention to the log information, and needs to resolve a fault problem in the log information in time, to ensure subsequent normal operation of a system. When log information of an alarm type is recorded in the log file, the administrator needs to pay more attention to the log information, and needs to resolve a fault problem in the log information as soon as possible, to avoid a risk of abnormality occurring in a system during operation. When log information of an information type is recorded in the log file, the administrator may pay some attention to the log information during daily operation and maintenance work, and thus can correct key information of a system in time when an abnormality occurs, to maintain normal operation of the system. When log information of a debugging type is recorded in the log file, the administrator may use the log information as reference information while debugging a system, providing assistance for debugging and improving the efficiency of debugging the system by the administrator.

TABLE 5

| Classification | Description |
|---|---|
| Configuration | Record behaviors of user of adding, deleting, and |
| log | modifying configuration. |
| Manage and | Record system operation management and control |
| control log | behavior. |
| Alarm log | Record system operation alarm information. |
| Background log | Record behaviors of system in entire background |
| | running process |

It can be seen from the content in Table 5 that when a configuration log is recorded in a log file, an administrator can learn various different system operation conditions such as an addition condition, a deletion condition, and a configuration modification condition of users according to the configuration log. When a management and control log is recorded in the log file, the administrator can learn, according to the management and control log, a management and control behavior for system operation. When an alarm log is recorded in the log file, the administrator can learn, according to the alarm log, alarm information that occurs in a system operation process, so that the alarm information can be corrected in time, maintaining normal operation of the system. When a background log is recorded in the log file, the administrator can learn, according to the background log, various system behaviors in an entire background running process of the system.

The instruction execution method based on a language model provided in the embodiments of the present disclosure is described in detail below by using specific examples.

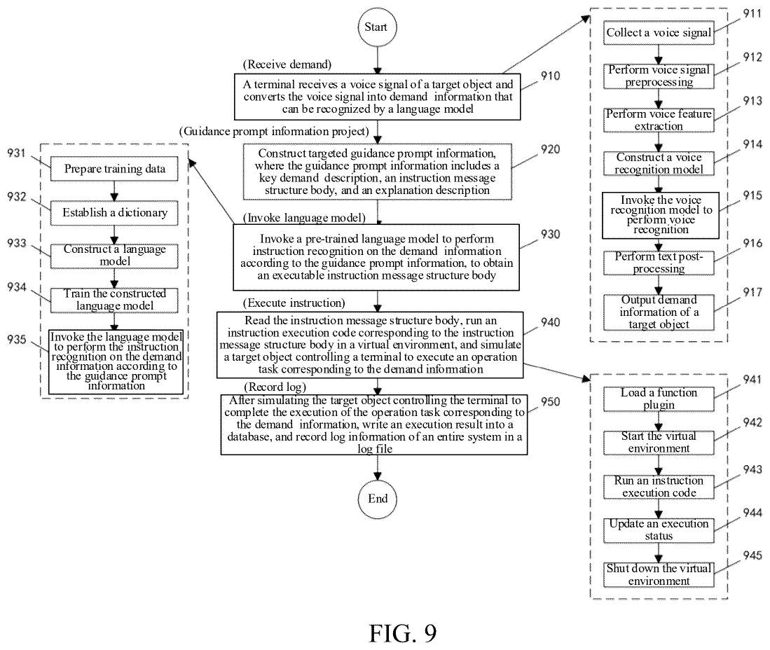

Referring to FIG. 9, FIG. 9 is an overall flowchart of an instruction execution method based on a language model in an example. In FIG. 9, the instruction execution method based on a language model may include, but is not limited to, operation 910 to operation 950.

Operation 910: A terminal receives a voice signal of a target object, and converts the voice signal into demand information that can be recognized by a language model.

This operation is an operation in which the terminal receives the demand information. In this operation, the terminal may receive the voice signal of the target object through various voice receiving software or hardware.

In this operation, while converting the voice signal into the demand information that can be recognized by the language model, the terminal may sequentially perform operations such as voice signal preprocessing, voice feature extraction, voice recognition, and text post-processing on the voice signal of the target object, to obtain the demand information that can be recognized by the language model, so that the language model can be invoked in subsequent operations to perform instruction recognition on the demand information.

In an embodiment, the process in which the terminal receives a voice signal of a target object and converts the voice signal into demand information that can be recognized by a language model may include the following operation 911 to operation 917.

Operation 911: Collect a voice signal.

In this operation, collecting a voice signal refers to receiving voice information inputted by a target object. The terminal may collect the voice signal of the target object through a voice receiving module disposed in the terminal (for example, a microphone disposed in the terminal), or may collect the voice signal of the target object through another external voice receiving module (for example, an external device such as an external recording device, another mobile phone, another tablet, or an industrial device). This is not specifically limited herein.

Operation 912: Perform voice signal preprocessing.

In this operation, voice signal preprocessing refers to performing at least one of noise removal and voice segmentation on the voice information, to obtain preprocessed voice information. After collecting the voice signal of the target object, the terminal may perform voice signal preprocessing on the voice signal of the target object. In an embodiment, the voice signal preprocessing performed by the terminal on the voice signal may include operations such as noise removal and voice segmentation. Noise removal is performed on the voice information, so that interference information such as ambient noise that is introduced in the voice information can be filtered, thereby improving the purity of the voice information. Voice segmentation is performed on the voice information, so that a long voice inputted by the target object can be segmented into a plurality of short voices, reducing the processing difficulty of subsequent voice feature extraction performed by a voice feature extraction model, thereby improving the accuracy and efficiency of voice feature extraction.

Operation 913: Perform voice feature extraction.

In this operation, the voice feature extraction refers to invoking a voice feature extraction model to perform voice feature extraction on the preprocessed voice information, to obtain voice feature information. After performing voice signal preprocessing on the voice signal to obtain preprocessed voice information, the terminal may perform voice feature extraction on the preprocessed voice information, and convert the voice signal into voice feature information in a digital signal form (for example, an audio feature vector), so that a subsequent voice recognition model can subsequently conveniently perform more accurate recognition on the voice feature information.

In an embodiment, a voice feature extraction model may be invoked to perform voice feature extraction on the voice signal. The voice feature extraction model may be a trained deep neural network model, a convolutional neural network model, or the like, or may be a mathematical model having voice feature extraction capability (for example, a mathematical model for performing MFCC processing on a voice signal, a mathematical model for performing DFT processing on a voice signal, or a mathematical model for performing PLP processing on a voice signal). Proper selection may be made according to a practical application situation, which is not specifically limited herein.

Operation 914: Construct a voice recognition model.

In this operation, constructing a voice recognition model refers to constructing a voice recognition model configured to perform voice recognition on the voice information and training the voice recognition model by using the voice feature information. After performing voice feature extraction on the voice signal to obtain voice feature information in a digital signal form, the terminal may construct a corresponding voice recognition model according to the obtained voice feature information, so that the voice recognition model can be used to perform the voice recognition on the voice feature information.

In an embodiment, the voice recognition model may be a model commonly used in the art, such as an HMM model, a Gaussian mixture model, a deep neural network model, an n-gram language model, or another statistical model. This is not specifically limited herein.

Operation 915: Invoke a voice recognition model to perform voice recognition.

In this operation, invoking a voice recognition model to perform voice recognition refers to invoking a trained voice recognition model to perform the voice recognition on the voice feature information, to obtain text information. After the terminal constructs the voice recognition model, the terminal may invoke the voice recognition model to perform the voice recognition on the voice feature information, to obtain text information corresponding to the voice signal of the target object.

In an embodiment, when the voice recognition model includes an acoustic model and a language model, while the voice recognition model is invoked to perform the voice recognition on the voice feature information, the acoustic model may be first invoked to convert the voice feature information into an intermediate recognition result (for example, a phoneme, a phoneme string, or a subword), then the language model is invoked to convert the intermediate recognition result into a text recognition result (for example, a word, a word string, or a symbol sequence), and then text information corresponding to the voice signal of the target object is outputted, to complete the voice recognition on the voice feature information.

Operation 916: Perform text post-processing.

In this operation, the text post-processing refers to performing at least one processing of adding punctuations, correcting spelling errors, or correcting word order errors for the text information obtained by the voice recognition, to obtain the demand information of the target object. After the terminal invokes the voice recognition model to perform the voice recognition on the voice feature information to obtain the corresponding text information, the terminal may perform at least one processing of adding punctuations, correcting spelling errors, or correcting word order errors for the text information, to obtain demand information corresponding to the voice signal of the target object.

Operation 917: Output demand information of a target object.

In this operation, after completing the text post-processing on the text information outputted by the voice recognition model, the terminal may output text content obtained after the text post-processing, and this text content is the demand information of the target object.

Through the processing from operation 911 to operation 917, the voice signal of the target object may be converted into the demand information that can be recognized by the language model, so that in subsequent operations, the language model can be invoked to perform the instruction recognition on the demand information, to obtain an execution instruction corresponding to the voice signal of the target object.

Operation 920: Construct targeted guidance prompt information, where the guidance prompt information includes a key requirement description, an instruction message structure body, and an explanation description.

In this operation, the guidance prompt information is a text segment or prompt information provided for starting the language model. The guidance prompt information may be a word, a phrase, a sentence, a paragraph, or an entire article. This is not specifically limited herein. When the guidance prompt information is inputted into the language model for voice recognition, the language model may generate a complete text according to the guidance prompt information, and the language model may make the generated text conform to a subject, a tone, and a style of the guidance prompt information as much as possible. Therefore, the guidance prompt information including the key requirement description, the instruction message structure body, and the explanation description is constructed, so that when the language model is invoked in a subsequent operation to perform the instruction recognition on the demand information according to the guidance prompt information, the language model can more accurately perform the instruction recognition on the demand information according to the content in the guidance prompt information. Thus, the confidence level of the instruction message structure body obtained through recognition can be increased, thereby obtaining an instruction message structure body having a higher matching degree with the demand information.

In an embodiment, the guidance prompt information may be composed of a plurality of pieces of instruction prompt information, and each piece of instruction prompt information includes a question prompt information part and an answer prompt information part. For each piece of instruction prompt information, a use scenario of a current instruction and a corresponding question description are described in detail in the question prompt information part, which may be used for instructing the language model to perform semantic recognition on question content in the use scenario of the current instruction. An instruction message structure body (including an instruction name, an instruction parameter, and the like) of the current instruction and corresponding instruction explanation are described in detail in the answer prompt information part, which may be used for instructing the language model to output corresponding answer content in the use scenario of the current instruction.

Operation 930: Invoke a pre-trained language model to perform instruction recognition on the demand information according to the guidance prompt information, to obtain an executable instruction message structure body.

In this operation, after the demand information is obtained and the guidance prompt information is constructed, the pre-trained language model may be invoked to perform the instruction recognition on the demand information according to the guidance prompt information, to obtain an executable instruction message structure body, so that in a subsequent operation, the terminal may automatically execute a corresponding operation task according to the executable instruction message structure body, to avoid repeated interaction of the target object, thereby improving the efficiency of interaction between the target object and the terminal.

In an embodiment, the language model may be an LLM model, an NLU model, or the like. Proper selection may be made according to a practical application situation, which is not specifically limited herein.

In an embodiment, the process of invoking a pre-trained language model to perform instruction recognition on the demand information according to the guidance prompt information may include the following operation 931 to operation 935.

Operation 931: Prepare training data.

In this operation, preparing training data refers to obtaining a training sample set for training a language model. The terminal may download public sample data set through a network in advance or generate sample data sets through a natural language generation model. These sample data sets may include various different types of natural linguistic data such as web page content, news content, or novel content. Then, the sample data sets and guidance prompt information are constructed into training sample data, and preprocessing such as cleaning, tokenization, and stop word removal is performed on the training sample data, to obtain a training sample set for training the language model.

Operation 932: Establish a dictionary.

In this operation, establishing a dictionary refers to establishing, according to text information in the training sample set, a dictionary for training a language model. The terminal may statistically collect and count vocabulary appearing in all text information in the training sample set, to establish a dictionary, and then generate a corresponding unique number for each word in the dictionary, so that the language model may be trained by using the dictionary in subsequent operations. Operation 933: Construct a language model.

In this operation, constructing a language model refers to constructing a language model for performing instruction recognition on demand information of the target object. The terminal may construct the language model by using a neural network, for example, may construct the language model by using a recurrent neural network. A recurrent neural network has a memory capability, and can memorize a previous input, thereby affecting a subsequent output. During construction of a language model, parameters may be set for the language model. For example, parameters such as a quantity of hidden layers and a learning rate may be set for the language model. In an embodiment, a quantity of hidden layers of the language model may be set to 12. To be specific, the language model may include 12 hidden layers. In addition, a learning rate of the language model may be set to 50%. This is not specifically limited herein.

Operation 934: Train the language model.

In this operation, training the language model refers to training the language model by using the training sample set. The terminal may input the training sample set that has been processed in the foregoing operation to the language model for training, and continuously adjust the parameters of the language model during training to minimize an error between a prediction result and an actual result (that is, the label) of the language model. When the error between the prediction result and the actual result of the language model is less than a preset error threshold, or a quantity of times of iterative training on the language model reaches a preset quantity threshold, it may be considered that the training on the language model is completed.

Operation 935: Invoke the language model to perform the instruction recognition on the demand information according to the guidance prompt information.

In this operation, once the training on the language model is completed, the language model may be used to perform the instruction recognition on the demand information of the target object according to the guidance prompt information.

Through the processing from operation 931 to operation 935, the language model may be constructed and training of the language model may be completed, so that the language model may perform the instruction recognition on the demand information of the target object according to the guidance prompt information, to obtain an executable instruction message structure body, so that in subsequent operations, the terminal may automatically execute a corresponding operation task according to the executable instruction message structure body.

Operation 940: Read the instruction message structure body, run an instruction execution code corresponding to the instruction message structure body in a virtual environment, and control the terminal to execute the operation task corresponding to the demand information.

In this operation, after the language model is invoked to perform the instruction recognition on the demand information according to the guidance prompt information to obtain the executable instruction message structure body, content in the instruction message structure body may be read, the instruction execution code corresponding to the instruction message structure body is obtained, and then the instruction execution code is run in the virtual environment, so that the terminal may simulate the target object controlling the terminal to execute the operation task corresponding to the demand information.

In an embodiment, the process of running the instruction execution code corresponding to the instruction message structure body in the virtual environment and simulating the target object controlling the terminal to execute the operation task corresponding to the demand information may include the following operation 941 to operation 945.

Operation 941: Load a function plugin.

In this operation, loading a function plugin refers to loading an instruction execution code corresponding to the instruction message structure body into a created execution record table. Before running the instruction execution code corresponding to the instruction message structure body, the terminal may first create an execution record table in an instruction running database. The execution record table may be configured for recording information such as a process relationship and execution time of instruction execution. Then a corresponding instruction execution code (that is, the function plugin) is obtained from an instruction execution code database according to an instruction name (or a plugin name) in the instruction message structure body, and the instruction execution code is loaded into the execution record table, so that the instruction execution code may be read from the execution record table and the instruction execution code may be run in subsequent operations.

Operation 942: Start a virtual environment.

In this operation, starting a virtual environment refers to starting, in the terminal, a virtual environment for running an instruction execution code. To implement simultaneous concurrent execution of different execution instructions, the terminal may simultaneously start a plurality of virtual environments (for example, a virtual image of an operating system with a desktop), so that different instruction execution codes may be simultaneously executed in different virtual environments, thereby implementing concurrent execution of different operation tasks by means of simultaneous running of a plurality of operating system images.

Operation 943: Run an instruction execution code.

In this operation, running an instruction execution code refers to running an instruction execution process in a virtual environment that has already been started, and invoking the instruction execution process to run the instruction execution code. When running the instruction execution code in the virtual environment to simulate the target object controlling the terminal to execute the operation task corresponding to the demand information, the terminal may first run the instruction execution process in the virtual environment, and then invoke the instruction execution process to run the instruction execution code, so that the terminal is controlled to execute the operation task corresponding to the demand information. When the instruction execution code is run in the virtual environment, a corresponding instruction execution process may be started in an operating system running in each virtual environment, and the instruction execution process may be configured for automatically simulating the target object's control operation on the terminal. For example, assuming that the terminal is a computer to which a mouse and a keyboard are connected, the instruction execution process may be configured for automatically simulating a control operation performed on the computer by the target object through the mouse and the keyboard. The simulated operation task corresponding to the demand information, which the target object controls the terminal to execute, may be various operation tasks that the target object can control the terminal to execute, for example, may include various different types of operation tasks such as starting an application program, inputting a text, clicking a button, and dragging a window.

Operation 944: Update an execution status.

In this operation, updating an execution status refers to updating, after simulating the target object controlling the terminal to complete the execution of the operation task corresponding to the demand information, content of an execution status entry in an execution record table as “Completed”, and writing an execution result into an execution result entry. After running the instruction execution code to simulate the target object controlling the terminal to complete the execution of the operation task corresponding to the demand information, the terminal may update the execution status of the instruction execution code in the execution record table as “Completed”, and write a corresponding execution result into an execution result entry in the execution record table. The execution status of the instruction execution code is recorded and updated by using the execution record table, so that the execution status of the instruction execution code can be managed and controlled in real time, thereby facilitating automatic execution of the operation task corresponding to the demand information by the terminal.

Operation 945: Shut down the virtual environment.

In this operation, shutting down the virtual environment means that after simulating the target object controlling the terminal to complete the execution of the operation task corresponding to the demand information, the terminal shuts down the virtual environment for running the instruction execution code. After simulating the target object controlling the terminal to complete the execution of the operation task corresponding to the demand information, the virtual environment may be shut down, to avoid resource waste.

Through the processing from operation 941 to operation 945, the terminal may simulate the target object controlling the terminal to execute the operation task corresponding to the demand information. This process is completed automatically, the target object does not need any additional operation, and the target object does not need repeated interaction. Therefore, the efficiency of interaction between the target object and the terminal can be improved, simplifying the use of the target object, thereby improving the use experience of the target object.

Operation 950: After simulating the target object controlling the terminal to complete the execution of the operation task corresponding to the demand information, write an execution result into a database, and record log information of the entire system in a log file.

In this operation, the execution result of simulating the target object controlling the terminal to complete the execution of the operation task corresponding to the demand information is written into the database, and the log information of the entire system is recorded in the log file, to implement information recording of an entire processing process, so that operation conditions of the terminal can be managed and controlled according to the log information in the log file, thereby implementing daily fault dropping and status recording for terminal operation.

In this embodiment, by using the instruction execution method based on a language model including the foregoing operation 910 to operation 950, when the voice signal of the target object is received, the voice signal is first converted into the demand information that can be recognized by the language model, then the targeted guidance prompt information is constructed, and then the pre-trained language model is invoked to perform the instruction recognition on the demand information according to the guidance prompt information, to obtain the executable instruction message structure body. Since, the executable instruction message structure body is obtained by performing the instruction recognition on the demand information by the language model according to the guidance prompt information, the confidence level of the instruction message structure body obtained through recognition can be increased, thereby obtaining an instruction message structure body having a higher matching degree with the demand information. After the executable instruction message structure body is obtained, the instruction execution code corresponding to the instruction message structure body is first run in the virtual environment, and simulating the target object controlling the terminal to execute the operation task corresponding to the demand information is performed. After simulating the target object controlling the terminal to complete the execution of the operation task corresponding to the demand information, the execution result is written into the database, and the log information of the entire system is recorded in the log file. The execution result of simulating the target object controlling the terminal to execute the operation task corresponding to the demand information is written into the database and the log information of the entire system is recorded in the log file, to implement the information recording of the entire processing process, so that the operation conditions of the terminal can be managed and controlled according to the log information in the log file, thereby implementing daily fault dropping and status recording for terminal operation. In addition, the instruction execution method is performed automatically by the terminal, the target object does not need any additional operation, and the target object does not need repeated interaction. Therefore, the efficiency of interaction between the target object and the terminal can be improved, simplifying the use of the target object, thereby improving the use experience of the target object.

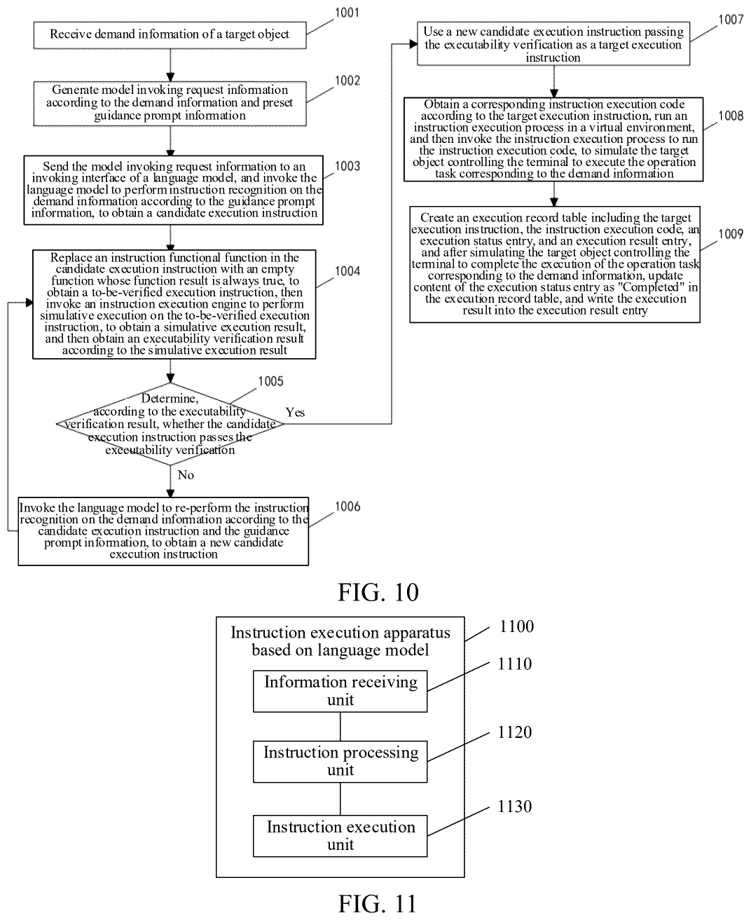

Referring to FIG. 10, FIG. 10 is a flowchart of operations of an instruction execution method based on a language model in a specific example. In FIG. 10, the instruction execution method based on a language model may include, but is not limited to, operation 1001 to operation 1009. Operation 1001: Receive demand information of a target object.

Operation 1002: Generate model-invoking request information according to the demand information and preset guidance prompt information.

Operation 1003: Send the model-invoking request information to an invoking interface of a language model, and invoke the language model to perform instruction recognition on the demand information according to the guidance prompt information, to obtain a candidate execution instruction. Operation 1004: Replace an instruction functional function in the candidate execution instruction with an empty function whose function result is logically true, to obtain a to-be-verified execution instruction, then invoke an instruction execution engine to perform simulative execution on the to-be-verified execution instruction, to obtain a simulative execution result, and then obtain an executability verification result according to the simulative execution result.

When executability verification is performed on the candidate execution instruction, since operations corresponding to the instruction functional function in the candidate execution instruction may be relatively complex, directly invoking the instruction execution engine to perform simulative execution on the candidate execution instruction may cause a problem of a relatively long execution time, thereby affecting the efficiency of performing the executability verification on the candidate execution instruction. Therefore, to reduce time consumption for performing the executability verification on the candidate execution instruction so as to improve the efficiency of the executability verification performed on the candidate execution instruction, the instruction functional function in the candidate execution instruction may be replaced with an empty function whose function result is logically true, to obtain the to-be-verified execution instruction. In this way, when the instruction execution engine is invoked to perform simulative execution on the to-be-verified execution instruction, the executability of the to-be-verified execution instruction may be verified relatively quickly, thereby improving the efficiency of performing the executability verification on the candidate execution instruction.

Operation 1005: Determine, according to an executability verification result, whether the candidate execution instruction passes the executability verification. Perform operation 1006 if the candidate execution instruction fails to pass the executability verification. Perform operation 1007 if the candidate execution instruction passes the executability verification.

In an embodiment, if the executability verification result is that the candidate execution instruction fails to pass the executability verification, it indicates that the candidate execution instruction recognized by the current language model is inaccurate and is not a legal executable execution instruction. Therefore, operation 1006 may be performed to invoke language model to re-perform the instruction recognition on the demand information according to the candidate execution instruction and the guidance prompt information. If the executability verification result is that the candidate execution instruction passes the executability verification, it indicates that the candidate execution instruction recognized by the current language model is an accurate and legal executable execution instruction. Therefore, operation 1007 may be performed.

Operation 1006: Invoke the language model to re-perform the instruction recognition on the demand information according to the candidate execution instruction and the guidance prompt information, to obtain a new candidate execution instruction, and perform operation 1004 again.

In an embodiment, when the language model is invoked to re-perform the instruction recognition on the demand information according to the candidate execution instruction and the guidance prompt information, model-invoking request information may be re-generated according to the candidate execution instruction obtained through recognition, the demand information of the target object, and the preset guidance prompt information, then the re-generated model-invoking request information is sent to the invoking interface of the language model, and the language model is invoked to re-perform the instruction recognition on the demand information according to the candidate execution instruction and the guidance prompt information. When the language model is invoked to re-perform the instruction recognition on the demand information for a plurality of times, the model-invoking request information may be re-generated according to a plurality of candidate execution instructions previously obtained through recognition, the demand information, and the guidance prompt information, and then the re-generated model-invoking request information is sent to the invoking interface of the language model, so that the language model is invoked to re-perform the instruction recognition on the demand information according to the plurality of candidate execution instructions previously obtained through recognition and the guidance prompt information, thereby increasing the confidence level of the candidate execution instruction newly obtained through recognition according to the plurality of candidate execution instructions previously obtained through recognition.

Operation 1007: Use the candidate execution instruction passing the executability verification as a target execution instruction.

In an embodiment, if the executability verification result obtained by performing the executability verification on the candidate execution instruction is that the candidate execution instruction passes the executability verification, it indicates that the candidate execution instruction is an execution instruction matching the demand information of the target object. Thus, there is no need to invoke the language model to re-perform the instruction recognition on the demand information, and the terminal may be directly controlled, according to the candidate execution instruction, to execute the operation task corresponding to the demand information. Therefore, the candidate execution instruction passing the executability verification may be used as the target execution instruction, so that the terminal may be controlled, according to the target execution instruction, to execute the operation task corresponding to the demand information in subsequent operations.

Operation 1008: Obtain a corresponding instruction execution code according to the target execution instruction, run an instruction execution process in a virtual environment, and then invoke the instruction execution process to run the instruction execution code, to simulate the target object to control the terminal to execute the operation task corresponding to the demand information.

In an embodiment, each target execution instruction has a corresponding instruction execution code, and a process of each operation of executing the target execution instruction is recorded in the instruction execution code. Therefore, the instruction execution code corresponding to the target execution instruction is obtained first, and then the instruction execution code is run in the virtual environment, to simulate the target object to control the terminal to execute the operation task corresponding to the demand information.

In an embodiment, to implement simultaneous concurrent execution of different execution instructions, after a plurality of target execution instructions are obtained and instruction execution codes corresponding to the target execution instructions are invoked, a plurality of virtual environments (for example, a virtual image of an operating system with a desktop) are simultaneously started, and instruction execution codes of different target execution instructions are simultaneously executed in different virtual environments, thereby implementing concurrent execution of different operation tasks by means of simultaneous running of a plurality of operating system images.

Operation 1009: Create an execution record table including the target execution instruction, the instruction execution code, an execution status entry, and an execution result entry, and after the terminal is controlled to complete the execution of the operation task corresponding to the demand information, update content of the execution status entry as “Completed” in the execution record table, and write the execution result into the execution result entry.

In an embodiment, an execution status of the instruction execution code is recorded and updated by using the execution record table, so that the execution status of the instruction execution code can be managed and controlled in real time, thereby facilitating automatic execution of the operation task corresponding to the demand information by the terminal.

By using the instruction execution method based on a language model including the foregoing operation 1001 to operation 1009, when the demand information of the target object is received, at least one round of target operation is executed, until the candidate execution instruction passing the executability verification is obtained. In the first round of target operation, the language model is first invoked to perform the instruction recognition on the demand information according to the preset guidance prompt information, to obtain the candidate execution instruction of the first round of target operation. The candidate execution instruction is obtained by performing, by the language model, the instruction recognition on the demand information according to the guidance prompt information. Therefore, the confidence level of the candidate execution instruction can be increased, thereby helping to obtain a candidate execution instruction having a higher matching degree with the demand information. Then, the executability verification is performed on the candidate execution instruction of the first round of target operation to determine whether the candidate execution instruction passes the executability verification; and if the candidate execution instruction fails to pass the executability verification, it indicates that the candidate execution instruction obtained by the current language model through recognition is inaccurate. In this case, a next round of target operation is performed. In the next round of target operation, the language model is invoked to re-perform the instruction recognition on the demand information according to the candidate execution instruction in the previous target operation and the guidance prompt information, to obtain a candidate execution instruction of this round of target operation, and then the executability verification is re-performed on this candidate execution instruction to determine whether this candidate execution instruction passes the executability verification. Several rounds of target operations are repeatedly performed in this way until a candidate execution instruction passing the executability verification is obtained. In addition, after the candidate execution instruction passing the executability verification is obtained, the candidate execution instruction is used as the target execution instruction, and the terminal is controlled, according to the target execution instruction, to execute the operation task corresponding to the demand information. The candidate execution instruction passing the executability verification is obtained by invoking the language model to perform the instruction recognition on the demand information according to the guidance prompt information and the previous candidate execution instruction for many times. Therefore, the confidence level of the candidate execution instruction can be ensured. Moreover, this process is automatically completed, the target object does not need any additional operation, and the target object does not need repeated interaction. Therefore, the efficiency of interaction between the target object and the terminal can be improved, simplifying the use of the target object, thereby improving the use experience of the target object.

Application scenarios of the embodiments of the present disclosure are described below with reference to some specific examples.

The instruction execution method based on a language model provided in the embodiments of the present disclosure may be applied to different application scenarios such as web page search and voice chat. A web page search scenario and a voice chat scenario are used as examples for description below.

### Scenario One

The instruction execution method based on a language model provided in the embodiments of the present disclosure may be applied to a web page search scenario. For example, assuming that a user sends, through an artificial intelligence interaction module of a terminal, demand information of searching a weather condition in a web page to the terminal, the terminal first receives the demand information through the artificial intelligence interaction module and then executes the instruction execution method provided in the embodiments of the present disclosure to obtain a target execution instruction corresponding to the demand information, and the terminal is controlled to execute, according to the target execution instruction, an operation task corresponding to the demand information. When the terminal is controlled to execute the operation task corresponding to the demand information, an application programming interface is first invoked to obtain screen resolution of a display module, initial coordinates of an operation cursor are obtained according to the screen resolution, then target coordinates of a search input box in the web page are determined, subsequently an operation of simulating a user to control the operation cursor to move from the initial coordinates to the target coordinates is performed to position the operation cursor on the search input box in the web page, and an operation of simulating the user to query for a weather condition through the search input box in the web page. In this case, the web page jumps to a page for displaying a weather condition, and the user may obtain desired weather condition from the page.

### Scenario Two

The instruction execution method based on a language model provided in the embodiments of the present disclosure may further be applied to a voice chat scenario. For example, assuming that a user chats with a friend through an instant messaging application program of a terminal, when the user enters, through an artificial intelligence interaction module in the terminal, demand information of sending chat information in the instant messaging application program, the terminal first receives the demand information through the artificial intelligence interaction module and then executes the instruction execution method provided in the embodiments of the present disclosure, to obtain a target execution instruction corresponding to the demand information, and then the terminal is controlled to execute, according to the target execution instruction, an operation task corresponding to the demand information. When the terminal is controlled to execute the operation task corresponding to the demand information, the application programming interface is first invoked to obtain screen resolution of a display module, initial coordinates of the operation cursor are obtained according to the screen resolution, then target coordinates of an information input box in the instant messaging application program are determined, subsequently an operation of simulating the user to control the operation cursor to move from the initial coordinates to the target coordinates is performed to position the operation cursor on the information input box in the instant messaging application program, and an operation of simulating the user to send the chat information through the information input box is performed. In this case, the chat information is displayed on a chat interface of the instant messaging application program.

Although the operations in the flowcharts are displayed sequentially according to the indication of arrows, these operations are not necessarily performed sequentially according to the sequence indicated by the arrows. Unless otherwise explicitly specified in the embodiments, execution of these operations is not strictly limited, and the operations may be performed in other sequences. Moreover, at least some of the operations in the flowcharts may include a plurality of operations or a plurality of stages. The operations or stages are not necessarily performed at the same time but may be performed at different time. Execution of the operations or stages is not necessarily sequentially performed, but may be performed in turn or alternately with other operations or at least some of operations or stages of other operations.

Referring to FIG. 11, an embodiment of the present disclosure further discloses an instruction execution apparatus based on a language model. The instruction execution apparatus 1100 can implement the instruction execution method based on a language model in the foregoing embodiments. The instruction execution apparatus 1100 includes:
an information receiving unit 1110, configured to receive demand information of a target object;
an instruction processing unit 1120, configured to: execute at least one round of the target operation until a candidate execution instruction passing executability verification is obtained, and in the first round of target operation, invoke the language model to perform instruction recognition on the demand information according to preset guidance prompt information, to obtain a candidate execution instruction of the first round of target operation, perform the executability verification on the candidate execution instruction of the first round of target operation to determine whether the candidate execution instruction of the first round of target operation passes the executability verification, and in an i^{th} round of target operation, invoke the language model to perform the instruction recognition on the demand information according to a candidate execution instruction of an (i−1)^{th} round of target operation and the guidance prompt information, to obtain a candidate execution instruction of the i^{th} round of target operation, and perform the executability verification on the candidate execution instruction of the i^{th} round of target operation to determine whether the candidate execution instruction of the i^{th} round of target operation passes the executability verification, i being an integer greater than 1; and
an instruction execution unit 1130, configured to use the candidate execution instruction passing the executability verification as a target execution instruction, and control, according to the target execution instruction, a terminal to execute an operation task corresponding to the demand information.

In an embodiment, the instruction processing unit 1120 is specifically configured to:
replace an instruction functional function in the candidate execution instruction with a target empty function, to obtain a to-be-verified execution instruction;
invoke an instruction execution engine to perform simulative execution on the to-be-verified execution instruction, to obtain a simulative execution result; and
determine, according to the simulative execution result, whether the candidate execution instruction passes the executability verification.

In an embodiment, the instruction processing unit 1120 is specifically configured to:
determine that the candidate execution instruction passes the executability verification when the simulative execution result indicates successful execution of the to-be-verified execution instruction; or
determine that the candidate execution instruction fails to pass the executability verification when the simulative execution result indicates unsuccessful execution of the to-be-verified execution instruction.

In an embodiment, the instruction execution unit 1130 is further configured to:
obtain a corresponding instruction execution code according to the target execution instruction; and
run the instruction execution code in a virtual environment and control the terminal to execute the operation task corresponding to the demand information.

In an embodiment, the instruction execution unit 1130 is further configured to:
run an instruction execution process in the virtual environment; and
invoke the instruction execution process to run the instruction execution code, and control the terminal to execute the operation task corresponding to the demand information.

In an embodiment, the terminal includes a display module, and the display module is configured to display an operation cursor. The instruction execution unit 1130 is further configured to: obtain initial coordinates of the operation cursor;
determine target coordinates, the target coordinates being coordinates for executing the operation task corresponding to the demand information;
control the operation cursor to move from the initial coordinates to the target coordinates; and
control, at the target coordinates, the terminal to execute the operation task corresponding to the demand information.

In an embodiment, the instruction execution unit 1130 is further configured to:
invoke an application programming interface to obtain screen resolution of the display module; and
obtain the initial coordinates of the operation cursor according to the screen resolution.

In an embodiment, the instruction execution apparatus 1100 further includes:
record table creating unit, configured to create an execution record table including the target execution instruction and the instruction execution code, the execution record table further including an execution status entry and an execution result entry; and
record table updating unit, configured to update content of the execution status entry as “Completed” in the execution record table and write an execution result into the execution result entry, after the terminal is controlled to complete the execution of the operation task corresponding to the demand information.

In an embodiment, the instruction processing unit 1120 is further configured to:
generate model-invoking request information according to the demand information and preset guidance prompt information; and
send the model-invoking request information to an invoking interface of the language model, and invoke the language model to perform instruction recognition on the demand information according to the guidance prompt information, to obtain a candidate execution instruction.

In an embodiment, the information receiving unit 1110 is further configured to:
receive voice information inputted by a target object;
invoke a pre-trained voice recognition model to perform voice recognition on the voice information, to obtain text information; and
perform at least one processing of adding punctuations, correcting spelling errors, or correcting word order errors for the text information, to obtain the demand information of the target object.

In an embodiment, the information receiving unit 1110 is further configured to:
perform at least one processing of noise removal and voice segmentation on the voice information, to obtain preprocessed voice information;
invoke a voice feature extraction model to perform voice feature extraction on the preprocessed voice information, to obtain voice feature information; and
invoke a pre-trained voice recognition model to perform voice recognition on the voice feature information, to obtain text information.

The instruction execution apparatus 1100 based on a language model in this embodiment can implement the instruction execution method based on a language model according to the foregoing embodiments. Therefore, the instruction execution apparatus 1100 based on a language model in this embodiment has the same technical principles and the same beneficial effects as the instruction execution method based on a language model according to the foregoing embodiments. To avoid repetition of the content, details are not described herein again.

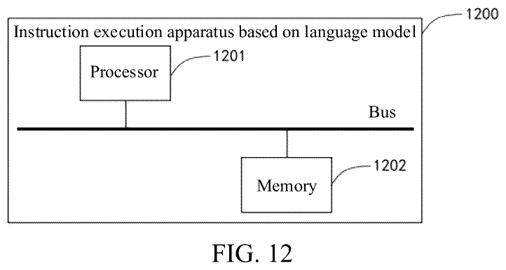

Referring to FIG. 12, an embodiment of the present disclosure further discloses a computer device for executing the instruction execution method based on a language model provided in the embodiments of the present disclosure. The computer device 1200 includes:
at least one processor 1201; and
at least one memory 1202, configured to store at least one program.

When the at least one program is executed by the at least one processor 1201, the foregoing instruction execution method based on a language model is implemented.

An embodiment of the present disclosure further provides a computer-readable storage medium having a processor-executable computer program stored therein, where the processor-executable computer program, when executed by a processor, is configured to implement the foregoing instruction execution method based on a language model.

An embodiment of the present disclosure further provides a computer program product including a computer program and computer instructions, where the computer program or the computer instructions are stored in a computer-readable storage medium, a processor of an instruction execution apparatus based on a language model reads the computer program or the computer instructions from the computer-readable storage medium, and the processor executes the computer program or the computer instructions to enable the instruction execution apparatus to execute the foregoing instruction execution method based on a language model.

In this manner, the present disclosure discloses an instruction execution method and apparatus based on a language model, and a storage medium. When demand information of a target object is received, a language model is first invoked to perform instruction recognition on the demand information according to guidance prompt information, to obtain a candidate execution instruction; then executability verification is performed on the candidate execution instruction; when the candidate execution instruction fails to pass the executability verification, the language model is invoked to re-perform the instruction recognition on the demand information according to the candidate execution instruction and the guidance prompt information, to obtain a new candidate execution instruction; subsequently, executability verification is re-performed on the new candidate execution instruction until executability verification succeeds; and then, the candidate execution instruction passing the executability verification is used as a target execution instruction, and a terminal is controlled, according to the target execution instruction, to execute an operation task corresponding to the demand information. Embodiments of the present disclosure can improve the interaction efficiency and user experience. The embodiments of the present disclosure can be applied to various application scenarios for interaction with artificial intelligence.

The embodiments of the present disclosure at least have the following beneficial effects. When the demand information of the target object is received, at least one round of target operation is executed until a candidate execution instruction passing the executability verification is obtained. In the first round of target operation, the language model is first invoked to perform the instruction recognition on the demand information according to the preset guidance prompt information, to obtain the candidate execution instruction of the first round of target operation. The candidate execution instruction is obtained by performing, by the language model, the instruction recognition on the demand information according to the guidance prompt information. Therefore, the confidence level of the candidate execution instruction can be increased, thereby helping to obtain a candidate execution instruction having a higher matching degree with the demand information. Then, the executability verification is performed on the candidate execution instruction of the first round of target operation to determine whether the candidate execution instruction passes the executability verification; and if the candidate execution instruction fails to pass the executability verification, it indicates that the candidate execution instruction obtained by the current language model through recognition is inaccurate. In this case, a next round of target operation is performed. In the next round of target operation, the language model is invoked to re-perform the instruction recognition on the demand information according to the candidate execution instruction in the previous target operation and the guidance prompt information, to obtain a candidate execution instruction of this round of target operation, and then the executability verification is re-performed on this candidate execution instruction to determine whether this candidate execution instruction passes the executability verification. Several rounds of target operations are repeatedly performed in this way until a candidate execution instruction passing the executability verification is obtained. In addition, after the candidate execution instruction passing the executability verification is obtained, the candidate execution instruction is used as the target execution instruction, and the terminal is controlled, according to the target execution instruction, to execute the operation task corresponding to the demand information. The candidate execution instruction passing the executability verification is obtained by invoking the language model to perform the instruction recognition on the demand information according to the guidance prompt information and the previous candidate execution instruction for many times. Therefore, the confidence level of the candidate execution instruction can be ensured. Moreover, this process is automatically completed, the target object does not need any additional operation, and the target object does not need repeated interaction. Therefore, the efficiency of interaction between the target object and the terminal can be improved, simplifying the use of the target object, thereby improving the use experience of the target object.

The terms such as “first”, “second”, “third”, and “fourth” (if exist) in the specification of the present disclosure and in the accompanying drawings are used for distinguishing between similar objects and not necessarily used for describing any particular order or sequence. Data used in this way is exchangeable in a proper case, so that the embodiments of the present disclosure described herein can be implemented in an order different from the order shown or described herein. In addition, the terms “comprise”, “include”, and any of their variants are intended to cover non-exclusive inclusion. For example, a process, a method, a system, a product, or an apparatus that includes a series of steps or units is not necessarily limited to that expressly listed operations or units, but may include other steps or units not expressly listed or inherent to the process, the method, the product, or the apparatus.

In the present disclosure, “at least one (item)” means one or more, and “a plurality of” means two or more. The term “and/or” is used for describing an association relationship between associated objects and representing that three relationships may exist. For example, “A and/or B” may represent the following three cases: only A exists, both A and B exist, and only B exists, where A and B may be singular or plural. The character “/” in this specification generally indicates an “or” relationship between the contextually associated objects. “At least one item (piece) of the following” or a similar expression means any combination of these items, including a single item (piece) or any combination of a plurality of items (pieces). For example, at least one (piece) of a, b, or c may represent: a, b, c, “a and b”, “a and c”, “b and c”, or “a, b, and c”, where a, b, and c may be singular or plural.

In several embodiments provided in the present disclosure, the disclosed system, apparatus, and method may be implemented in other manners. For example, the described apparatus embodiment is merely an example. For example, the unit division is merely a logical function division and may be other division during actual implementation. For example, a plurality of units or components may be combined or integrated into another system, or some features may be ignored or not performed. In addition, the displayed or discussed mutual couplings or direct couplings or communication connections may be indirect couplings or communication connections implemented through some interfaces, apparatuses or units, and may be implemented in electronic, mechanical, or other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments.

In addition, functional units in the embodiments of the present disclosure may be integrated into one processing unit, or each of the units may be physically separated, or two or more units may be integrated into one unit. The integrated unit may be implemented in the form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the related technology, or all or some of the technical solutions may be implemented in the form of a software product. The computer software product is stored in a storage medium and includes several instructions for instructing a computer apparatus (which may be a personal computer, a server, a network device, or the like) to perform all or some of the steps of the methods described in the embodiments of the present disclosure. The foregoing storage medium includes: various media capable of storing program codes, such as a USB flash disk, a mobile hard disk, a read-only memory (ROM), a random access memory (RAM), a magnetic disk, or an optical disc.

Numbering of operations in the foregoing method embodiments is merely set for ease of illustration and description, and an order of the operations is not limited. An execution order of the operations in the embodiments may be adaptively adjusted according to understanding of a person skilled in the art.

What is claimed is:

1. An instruction execution method based on a language model, performed by a computer device and comprising:
receiving demand information of a target object;
executing at least one round of target operation until a candidate execution instruction passing executability verification is obtained; in a first round of target operation, invoking the language model to perform instruction recognition on the demand information according to preset guidance prompt information, to obtain a candidate execution instruction of the first round of target operation, and performing the executability verification on the candidate execution instruction of the first round of target operation to determine whether the candidate execution instruction of the first round of target operation passes the executability verification; in an i^{th} round of target operation, invoking the language model to perform the instruction recognition on the demand information according to a candidate execution instruction of an (i−1)^{th} round of target operation and the guidance prompt information, to obtain a candidate execution instruction of the i^{th} round of target operation, and performing the executability verification on the candidate execution instruction of the i^{th} round of target operation to determine whether the candidate execution instruction of the i^{th} round of target operation passes the executability verification, i being an integer greater than 1; and
using the candidate execution instruction passing the executability verification as a target execution instruction, and controlling, according to the target execution instruction, a terminal to execute an operation task corresponding to the demand information.

2. The method according to claim 1, wherein an operation of the executability verification comprises:
replacing an instruction functional function in the candidate execution instruction with a target empty function, to obtain a first execution instruction for verification;
invoking an instruction execution engine to perform simulative execution on the first execution instruction for verification, to obtain a simulative execution result; and
determining, according to the simulative execution result, whether the candidate execution instruction passes the executability verification.

3. The method according to claim 2, wherein determining, according to the simulative execution result, whether the candidate execution instruction passes the executability verification comprises:
determining that the candidate execution instruction passes the executability verification when the simulative execution result indicates a successful execution of the first execution instruction; or
determining that the candidate execution instruction fails to pass the executability verification when the simulative execution result indicates an unsuccessful execution of the first execution instruction.

4. The method according to claim 3, wherein controlling, according to the target execution instruction, the terminal to execute the operation task corresponding to the demand information comprises:
obtaining an instruction execution code according to the target execution instruction; and
running the instruction execution code in a virtual environment and controlling the terminal to execute the operation task corresponding to the demand information.

5. The method according to claim 4, wherein running the instruction execution code in the virtual environment and controlling the terminal to execute the operation task corresponding to the demand information comprises:
running an instruction execution process in the virtual environment; and
invoking the instruction execution process to run the instruction execution code, and controlling the terminal to execute the operation task corresponding to the demand information.

6. The method according to claim 4, wherein the terminal comprises a display module, and the display module is configured to display an operation cursor; and
controlling the terminal to execute the operation task corresponding to the demand information comprises:
obtaining initial coordinates of the operation cursor;
determining target coordinates, the target coordinates being coordinates for executing the operation task corresponding to the demand information;
controlling the operation cursor to move from the initial coordinates to the target coordinates; and
controlling, at the target coordinates, the terminal to execute the operation task corresponding to the demand information.

7. The method according to claim 6, wherein obtaining the initial coordinates of the operation cursor comprises:
invoking an application programming interface to obtain screen resolution of the display module; and
obtaining the initial coordinates of the operation cursor according to the screen resolution.

8. The method according to claim 4, further comprising:
creating an execution record table comprising the target execution instruction and the instruction execution code, the execution record table further comprising an execution status entry and an execution result entry; and
updating, after controlling the terminal to complete the operation task corresponding to the demand information, content of the execution status entry in the execution record table to “Completed”, and writing an execution result into the execution result entry.

9. The method according to claim 1, wherein invoking the language model to perform instruction recognition on the demand information according to the preset guidance prompt information, to obtain the candidate execution instruction of the first round of target operation comprises:
generating model-invoking request information according to the demand information and the guidance prompt information; and
transmitting the model-invoking request information to an invoking interface of the language model, and invoking the language model to perform the instruction recognition on the demand information according to the guidance prompt information, to obtain the candidate execution instruction.

10. The method according to claim 1, wherein receiving the demand information of the target object comprises:
receiving voice information inputted by the target object;
invoking a pre-trained voice recognition model to perform voice recognition on the voice information, to obtain text information; and
performing at least one processing of adding punctuations, correcting spelling errors, or correcting word order errors for the text information, to obtain the demand information.

11. The method according to claim 10, wherein invoking the pre-trained voice recognition model to perform the voice recognition on the voice information, to obtain the text information comprises:
performing at least one processing of noise removal and voice segmentation on the voice information, to obtain preprocessed voice information;
invoking a voice feature extraction model to perform voice feature extraction on the preprocessed voice information, to obtain voice feature information; and
invoking the pre-trained voice recognition model to perform the voice recognition on the voice feature information, to obtain the text information.

12. A computer device, comprising:
one or more processors; and
at least one memory, configured to store at least one program that, when being executed causes the one or more processors to perform:
receiving demand information of a target object;
executing at least one round of target operation until a candidate execution instruction passing executability verification is obtained; in a first round of target operation, invoking the language model to perform instruction recognition on the demand information according to preset guidance prompt information, to obtain a candidate execution instruction of the first round of target operation, and performing the executability verification on the candidate execution instruction of the first round of target operation to determine whether the candidate execution instruction of the first round of target operation passes the executability verification; in an i^{th} round of target operation, invoking the language model to perform the instruction recognition on the demand information according to a candidate execution instruction of an (i−1)^{th} round of target operation and the guidance prompt information, to obtain a candidate execution instruction of the i^{th} round of target operation, and performing the executability verification on the candidate execution instruction of the i^{th} round of target operation to determine whether the candidate execution instruction of the i^{th} round of target operation passes the executability verification, i being an integer greater than 1; and
using the candidate execution instruction passing the executability verification as a target execution instruction, and controlling, according to the target execution instruction, a terminal to execute an operation task corresponding to the demand information.

13. The device according to claim 12, wherein the one or more processors are further configured to perform an operation of the executability verification comprising:
replacing an instruction functional function in the candidate execution instruction with a target empty function, to obtain a first execution instruction for verification;
invoking an instruction execution engine to perform simulative execution on the first execution instruction for verification, to obtain a simulative execution result; and
determining, according to the simulative execution result, whether the candidate execution instruction passes the executability verification.

14. The device according to claim 13, wherein the one or more processors are further configured to perform:
determining that the candidate execution instruction passes the executability verification when the simulative execution result indicates a successful execution of the first execution instruction; or
determining that the candidate execution instruction fails to pass the executability verification when the simulative execution result indicates an unsuccessful execution of the first execution instruction.

15. The device according to claim 14, wherein the one or more processors are further configured to perform:
obtaining an instruction execution code according to the target execution instruction; and
running the instruction execution code in a virtual environment and controlling the terminal to execute the operation task corresponding to the demand information.

16. The device according to claim 15, wherein the one or more processors are further configured to perform:
running an instruction execution process in the virtual environment; and
invoking the instruction execution process to run the instruction execution code, and controlling the terminal to execute the operation task corresponding to the demand information.

17. The device according to claim 15, wherein the terminal comprises a display module, and the display module is configured to display an operation cursor; and
the one or more processors are further configured to perform:
obtaining initial coordinates of the operation cursor;
determining target coordinates, the target coordinates being coordinates for executing the operation task corresponding to the demand information;
controlling the operation cursor to move from the initial coordinates to the target coordinates; and
controlling, at the target coordinates, the terminal to execute the operation task corresponding to the demand information.

18. The device according to claim 17, wherein the one or more processors are further configured to perform:
invoking an application programming interface to obtain screen resolution of the display module; and
obtaining the initial coordinates of the operation cursor according to the screen resolution.

19. The device according to claim 15, wherein the one or more processors are further configured to perform:
creating an execution record table comprising the target execution instruction and the instruction execution code, the execution record table further comprising an execution status entry and an execution result entry; and
updating, after controlling the terminal to complete the operation task corresponding to the demand information, content of the execution status entry in the execution record table to “Completed”, and writing an execution result into the execution result entry.

20. A non-transitory computer-readable storage medium containing a computer program that, when being executed causes at least one processor to perform:
receiving demand information of a target object;
executing at least one round of target operation until a candidate execution instruction passing executability verification is obtained; in a first round of target operation, invoking the language model to perform instruction recognition on the demand information according to preset guidance prompt information, to obtain a candidate execution instruction of the first round of target operation, and performing the executability verification on the candidate execution instruction of the first round of target operation to determine whether the candidate execution instruction of the first round of target operation passes the executability verification; in an i^{th} round of target operation, invoking the language model to perform the instruction recognition on the demand information according to a candidate execution instruction of an (i−1)^{th} round of target operation and the guidance prompt information, to obtain a candidate execution instruction of the i^{th} round of target operation, and performing the executability verification on the candidate execution instruction of the i^{th} round of target operation to determine whether the candidate execution instruction of the i^{th} round of target operation passes the executability verification, i being an integer greater than 1; and
using the candidate execution instruction passing the executability verification as a target execution instruction, and controlling, according to the target execution instruction, a terminal to execute an operation task corresponding to the demand information.
